(19) United States
(12) Patent Application Publication
(10) Pub. No.: US 2015/0012646 A1
(43) Pub. Date: Jan. 8, 2015

(54) MEDIA CONTROL DEVICE, MEDIA CONTROL TARGET DEVICE, AND METHODS OF OPERATING SUCH DEVICES

(71) Applicant: LG ELECTRONICS INC., Seoul (KR)

(72) Inventors: Seungryul Yang, Seoul (KR); Jaekoo Lee, Seoul (KR); Beomjin Jeon, Seoul (KR)

(73) Assignee: LG ELECTRONICS INC., Seoul (KR)

(21) Appl. No.: 14/373,280

(22) PCT Filed: Jan. 21, 2013
(86) PCT No.: PCT/KR2013/000480

§ 371 Date: Jul. 18, 2014

Related U.S. Application Data
(60) Provisional application No. 61/588,179, filed on Jan. 19, 2012.

(51) Int. Cl. H04L 12/26

(52) U.S. Cl. CPC H04L 43/10; H04L 43/50
USPC 709/224

(57) ABSTRACT

A media control device transmits an HDMI connection validation message based on a home network protocol to a first media control target device via an IP-based home network. The first media control target device transmits a first message based on a CEC protocol to the second media control target device via a CEC-based network. The media control device receives an HDMI connection information message based on the home network protocol via the IP-based home network. The media control device validates an HDMI connection between the first media control target device and the second media control target device on the basis of the HDMI connection information message.

### TECHNICAL FIELD

The present disclosure relates to a media control device and a media control target device, and more particularly, to a method for controlling AV content transmission/reception between universal plug and play (UPnP) devices.

### BACKGROUND ART

UPnP technology and digital living network alliance (DLNA) technology are types of home network protocols.

The UPnP technology and the DLNA technology enable electronic devices of various manufactures to provide services to each other and control each other. In particular, the UPnP technology enables provision and control of audio-visual (AV) services compatible between AV devices. The compatible AV services include media steaming, uploading and downloading.

The DLNA regulates home network devices such as a digital media server (DMS), a digital media player (DMP), a digital media renderer (DMR), a digital media controller (DMC), and a digital media printer (DMPr), and regulates mobile devices such as a mobile digital media server (M-DMS), a mobile digital media player (M-DMP), a mobile digital media uploader (M-DMU), a mobile digital media downloader (M-DMD), and a mobile digital media controller (M-DMC).

Hereinafter, the DMS also refers to the M-DMS, the DMP also refers to the M-DMP, and the DMC also refers to the M-DMC.

The UPnP technology classifies such devices into control point (CP) devices and control target devices. The DMC and DMP may be classified as CP devices, and the DMR, DMS, and DMPr may be classified as control target devices.

The DLNA technology defines a 2-box model and a 3-box model.

The 2-box model includes the DMP and the DMS. In the 2-box model, the DMP enables a user to search for and play content browsed and distributed by the DMS.

The 3-box model includes the DMC, the DMS, and the DMR. In the 3-box model, the DMC enables the user to search for content of the DMS to be played in the DMR.

Devices compliant with the UPnP and DLNA send and receive commands through internet protocol (IP) networking. That is, one of AV devices connected to the same network may provide an AV service to another device, may receive an AV service from another device, may control another device, or may be controlled by another device.

However, a regulation for exchanging information between an IP-based home network and a CEC network has not yet been established. Therefore, a control point device according to the related art is unable to ascertain HDMI connection relations between a plurality of control target devices.

### DISCLOSURE OF THE INVENTION

### Technical Problem

Embodiments provide a media control device, a media control target device and methods for operating the same for efficiently detecting HDMI connection relations among a plurality of control target devices.

### Technical Solution

In one embodiment, a method for operating a media control device for controlling a first media control target device and a second media control target device includes transmitting an HDMI connection validation message based on a home network protocol to the first media control target device via an IP-based home network so that the first media control target device transmits a first message based on a CEC protocol to the second media control target device via a CEC-based network, receiving an HDMI connection information message based on the home network protocol via the IP-based home network, and validating an HDMI connection between the first media control target device and the second media control target device on the basis of the HDMI connection information message.

In another embodiment, a method for operating a first media control target device controlled by a media control device includes receiving an HDMI connection validation message based on a home network protocol from the media control device via an IP-based home network, and transmitting a first message based on a CEC protocol to a second media control target device via a CEC-based network upon receiving the HDMI connection validation message, so that the first media control target device or the second media control target device transmits an HDMI connection information message based on the home network protocol to the media control device via the IP-based home network, and the media control device validates an HDMI connection between the first media control target device and the second media control target device on the basis of the HDMI connection information message.

In further another embodiment, a method for operating a second media control target connected by an HDMI connection to a first media control target device controlled by a media control device includes receiving, via a CEC-based network, a first message based on a CEC protocol from the media control device receiving an HDMI connection validation message based on a home network protocol via an IP-based home network, and transmitting an HDMI connection information message based on the home network protocol to the media control device via the IP-based home network, so that the media control device validates the HDMI connection between the first control target device and the second media control target device on the basis of the HDMI connection information message.

### Advantageous Effects

According to embodiments, UPnP devices are enabled to exchange content using an HDMI interface, so that an AV service can be efficiently provided and adaptive content streaming depending on a network state is allowed.

According to embodiments, HDMI connection relations among a plurality of control target devices can be efficiently detected.

### BRIEF DESCRIPTION OF THE DRAWINGS

FIG. 1 is a block diagram illustrating a UPnP network according to an embodiment.

FIG. 2 is a schematic block diagram illustrating a content transmitting/receiving system according to an embodiment.

FIG. 3 is a flowchart illustrating a content transmission/reception control method according to an embodiment.

FIG. 4 is a ladder diagram illustrating a first example of a method for receiving CEC address information of UPnP devices.

FIG. 5 is a diagram illustrating an example of an action defined to request CEC address information.

FIGS. 6 to 13 are diagrams illustrating examples of information on devices discovered by a control device (CP).

FIG. 14 is a schematic block diagram illustrating a content transmitting/receiving system according to another embodiment.

FIG. 15 is a diagram illustrating an example of information on devices discovered by a control device (CP) in the 2-box model illustrated in FIG. 14.

FIG. 16 is a schematic block diagram illustrating a content transmitting/receiving system according to another embodiment.

FIGS. 17 to 22 are diagrams illustrating examples of information on devices discovered by a control device (CP) in the system illustrated in FIG. 14.

FIG. 23 is a ladder diagram illustrating a second example of a method for receiving CEC address information of UPnP devices.

FIG. 24 is a diagram illustrating an example of protocol information received by a control device (CP).

FIGS. 25 and 26 are diagrams illustrating an example of a method for validating an HDMI connection between a source device and a sink device.

FIG. 27 is a block diagram illustrating a 3-box model according to an embodiment.

FIG. 28 is a block diagram illustrating a 2-box model according to an embodiment.

FIG. 29 is a diagram illustrating a network topology of an HDMI connection validating method according to an embodiment.

FIG. 30 is a diagram illustrating a network topology of an HDMI connection validating method according to an embodiment.

FIG. 31 is a diagram illustrating a network topology of an HDMI connection validating method based on an HDMI connection validation test message according to an embodiment.

FIG. 32 is a diagram illustrating a network topology of an HDMI connection validating method based on an HDMI connection validation test message according to an embodiment.

FIG. 33 is a diagram illustrating a network topology of an HDMI connection validating method based on an HDMI connection validation test message according to another embodiment.

FIG. 34 is a diagram illustrating a network topology of an HDMI connection validating method based on an HDMI connection validation test message in a 3-box model according to an embodiment.

FIG. 35 is a diagram illustrating a network topology of an HDMI connection validating method based on an HDMI connection validation test message in a 2-box model according to an embodiment.

FIG. 36 is a diagram illustrating a network topology of an HDMI connection validating method based on an HDMI connection validation test message in a 2-box model according to an embodiment.

FIG. 37 is a diagram illustrating a network topology of an HDMI connection validating method based on an HDMI connection validation test message according to another embodiment.

FIG. 38 is a diagram illustrating a network topology of an HDMI connection validating method based on an HDMI connection validation test message in a 3-box model according to another embodiment.

FIG. 39 is a diagram illustrating a network topology of an HDMI connection validating method based on an HDMI connection validation test message in a 3-box model according to another embodiment.

FIG. 40 is a diagram illustrating a network topology of an identifier-based HDMI connection validating method according to an embodiment.

FIG. 41 is a diagram illustrating a network topology of an identifier-based HDMI connection validating method according to an embodiment.

FIG. 42 is a diagram illustrating a network topology of an identifier-based HDMI connection validating method according to an embodiment.

FIG. 43 is a diagram illustrating a network topology of an identifier-based HDMI connection validating method in a 3-box model according to an embodiment.

FIG. 44 is a diagram illustrating a network topology of an identifier-based HDMI connection validating method in a 2-box model according to an embodiment.

FIG. 45 is a diagram illustrating a network topology of an identifier-based HDMI connection validating method in a 2-box model according to an embodiment.

FIG. 46 is a diagram illustrating a network topology of an identifier-based HDMI connection validating method according to an embodiment.

FIG. 47 is a diagram illustrating a network topology of an identifier-based HDMI connection validating method in a 3-box model according to an embodiment.

FIG. 48 is a diagram illustrating a network topology of an identifier-based HDMI connection validating method in a 2-box model according to an embodiment.

FIG. 49 is a diagram illustrating a network topology of an identifier-based HDMI connection validating method according to an embodiment.

FIG. 50 is a diagram illustrating a network topology of an identifier-based HDMI connection validating method in a 3-box model according to an embodiment.

FIG. 51 is a diagram illustrating a network topology of an identifier-based HDMI connection validating method in a 2-box model according to an embodiment.

FIG. 52 is a diagram illustrating a network topology of an identifier-based HDMI connection validating method in a 2-box model according to an embodiment.

FIG. 53 is a diagram illustrating a network topology of an identifier-based HDMI connection validating method according to an embodiment.

### MODE FOR CARRYING OUT THE INVENTION

Embodiments of the present disclosure will be described with reference to the accompanying drawings. The configuration and operation illustrated in the drawings or described with reference to the drawings are provided as examples, and the technical concept and the essential configuration or operation of the present disclosure are not limited thereto.

The terms used herein have been selected from among general terms that are currently widely used in consideration of the functions of the embodiments, but may be changed depending on intentions of those skilled in the art, customary practice in the art, or the advent of new technology. Furthermore, some terms have been arbitrarily selected by the applicant. The meanings of such terms will be described in detail when necessary. Therefore, it should be understood that the terms used herein should be defined on the basis of the meanings of the terms and the content of the present disclosure.

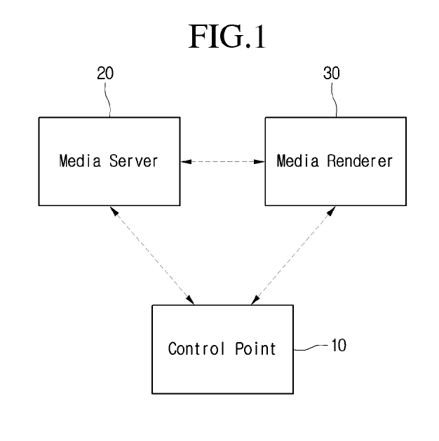

FIG. 1 is a block diagram illustrating a universal plug and play (UPnP) network according to an embodiment.

The UPnP technology, which is an extended standard based on Internet standards such as TCP/IP, HTTP and XML, enables networking, more specifically, home networking of network devices such as home appliances, network printers and Internet gates.

The UPnP network may be configured on the basis of a plurality of UPnP devices, a service, and a control point (CP).

The service represents a smallest control unit on the network, and is modeled using state variables.

The CP represents a control device for detecting and controlling other devices. An interface provided by the CP may allow a user to discover various devices, detect description information and control the devices.

Referring to FIG. 1, the UPnP network according to an embodiment may include a media server 20 for providing media data to a home network, a media renderer 30 for playing the media data through the home network, and a control point 10 for controlling the media server 20 and the media renderer 30.

The control point 10 may detect states of the media server 20 and the media renderer 30 on the basis of events.

In detail, AVTransport and Rendering Control input a changed state variable to a state variable referred to as LastChange and notifies it to the control point 10 after a lapse of a certain time so as to notify a current state of a device.

Furthermore, the media server 20 may notify information on content whenever UPnP action occurs, and content is transmitted between the media server 20 and the media renderer 30 in a streaming manner so that the content is played.

The content streaming may be performed using various streaming methods. According to a UPnP AV standard, an out-of-band transfer protocol is used to perform the content streaming without defining an additional streaming method.

For example, in the case where RTP is used to transmit content, RTCP may be used to monitor a transmission state of media data, and a transmission parameter may be controlled on the basis of the transmission state.

To describe the above-mentioned UPnP AV mechanism in more detail, the control point 10 may call a UPnP action provided on the basis of a standardized simple object access protocol (SOAP), so as to control the media server 20 and the media renderer 30.

Furthermore, the control point 10 may subscribe to an event service provided by a UPnP device so as to receive a report on a change of state information of a device.

The media server 20 may provide a ContentDirectory service for searching for media data managed by the server, a ConnectionManager service for managing a connection for streamlining between the media server 20 and the media renderer 30, and an AVTransport service for controlling media data, e.g., playing the media data or stopping the playing.

The media renderer 30 may provide a RenderingControl service for controlling brightness and lightness of a screen, a ConnectionManager service, and an AVTransport service 133.

Accordingly, the control point 10 may use the ContentDirectory service with respect to the discovered media server 20 and media renderer 30 so as to detect media file information of the server, may establish, on the basis of the information, a connection for transmitting/receiving content between the media server 20 and the media renderer 30 using the ConnectionManager service, and may play corresponding content using the AVTransport service.

The control point 10 may subscribe to events provided by each service so as to monitor information on a change of content of the media server 20 or a change of a state of current content stream.

The devices that form the UPnP network may be provided with UPnP middleware, wherein the UPnP middleware may support a networking function including processes of addressing, discovery, description, control, eventing, and presentation.

In the addressing process, UPnP devices search for a dynamic host configuration protocol (DHCP) server so as to be assigned with addresses and ports when initially accessing the UPnP network, or, in the case where the DHCP is not operated, the UPnP devices may automatically select and obtain IP addresses and ports within certain ranges by virtue of an automatic IP addressing function.

Here, different UPnP devices may obtain different IP addresses and ports through the addressing process, and UPnP devices that form one single board computer (SBC) may obtain the same IP address and different ports through the addressing process.

The UPnP devices that use IP addresses and ports assigned by the DHCP server or selected by the automatic IP addressing may communicate with other devices on the network through transmission control protocol (TCP)/IP.

The discovery process may be divided into an advertising step in which a UPnP device (e.g., the media server 20 or the media renderer 30) initially accesses the UPnP network and advertises itself to other devices operating on the UPnP network and a searching step in which a control device (e.g., the control point 10) initially accesses the UPnP network and searches for the UPnP devices operating on the UPnP network.

In the advertising step, UPnP devices that initially access the UPnP network and obtain IP addresses and ports through an addressing process may multicast advertising messages for advertising themselves to other devices that have accessed the UPnP network earlier than them so as to notify their access to the UPnP network to the other devices.

Thereafter, the control point 10 that has received the advertising message may register an IP address and a port of a corresponding UPnP device as registration control targets.

In the searching step, the control device that initially accesses the UPnP network, i.e., the control point (10), may obtain an IP address and a port through the addressing process, and may multicast a search message using a simple service discovery protocol (SSDP) in order to identify the UPnP devices operating on the network.

Accordingly, UPnP devices that have received the search message may unicast response messages to the control point 10, and the control point 10 may register IP addresses and ports of the UPnP devices that have unicast the response messages.

In the description process, the control point 10 sends a request for a device description file (e.g., a service description XML file or a device description XML file) to a UPnP device using an IP address registered in the advertising step in order to recognize a service provided by the UPnP device, and receives the device description file.

In the control process, the control point 10 analyzes the device description file obtained through the description process to recognize a service provided by a UPnP device, and then transmits a control command message for requesting execution of the service and receives a message of response to the control command message so as to control the UPnP device.

Here, the control command message and the control response message are control-related data and may be expressed in an XML using a simple object access protocol (SOAP).

In the eventing process, it is checked whether an event, e.g., a change of a state, occurs in the UPnP device that has provided a certain service in response to the control command message received from the control point 10.

In this case, when the control point 10 transmits a message for requesting subscription to the UPnP device in order to check a state change of the UPnP device, the UPnP device may transmit, to the control point 10, a text-type event message using a general event notification architecture (GENA) in order to notify the state change.

In the presentation process, the control point 10 reads an HTML page of the UPnP device, wherein the HTML page may provide a user interface for controlling a device so that a state of a controlled device may be presented.

The control point 10, the media server 20 and the media renderer 30 may transmit/receive data through an IP-based interface such as “Ethernet”, “USB”, “802.11”, “HSDPA”, “HomePNA”, “HomePlug”, “MoCA”, “G.hn” or “UPA”. Therefore, although not illustrated in FIG. 1, an access point or a relay device for the IP-based interface may be further provided.

The configuration of the UPnP network described above with reference to FIG. 1 is merely an example of the present disclosure, and thus the present disclosure is not limited thereto.

According to an embodiment, UPnP devices, e.g., the media server 20 and the media renderer 30, may be connected to each other using a high definition multimedia interface (HDMI).

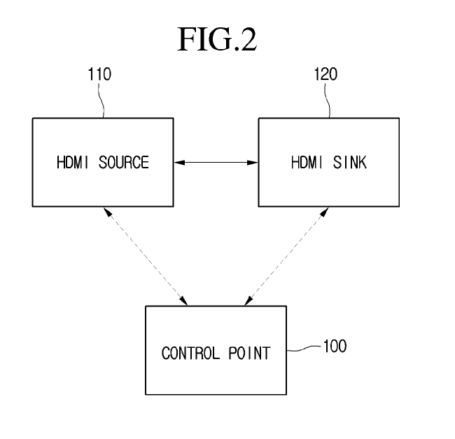

FIG. 2 is a block diagram illustrating a content transmitting/receiving system according to an embodiment. The system may include a source device and a sink device connected to each other through an HDMI. In the block diagrams of the drawings, data transmission/reception through the HDMI is represented by a solid line, and data transmission/reception through an IP-based interface is represented by a dotted line.

The HDMI is a digital interface based on a digital video interactive (DVI) that is a standard for connecting a PC to a monitor. The HDMI allows high-definition image and sound to be transmitted/received.

The HDMI has three independent channels, i.e., transition minimized differential signaling (TMDS), display data channel (DDC) and consumer electronics control (CEC), which are established by one physical cable, through which AV data, device information and a control command may be transmitted/received.

Referring to FIG. 2, an HDMI source 110 that is a source device transmits AV data through an HDMI cable, and an HDMI sink 120 that is a sink device may represent a device positioned at the top of a link for receiving the AV data, from among devices connected through the HDMI cable.

All devices should have valid CEC addresses, i.e., a physical address and a logical address, in order to perform HDMI CEC communication.

The logical address may be assigned by pinging adjacent devices, and the physical address may be assigned by performing HDMI hot plug detection (HPD).

For example, a TV system that is a root device may have a physical address of ‘0.0.0.0’, and a remaining source device may read and obtain a physical address from an extended display identification data (EDID) ROM of the sink device through display data channel (DDC) communication. The DDC communication may be performed when a +5 V power supply signal applied by the source device is fed back from the sink device and applied to an HPD line.

That is, upon receiving an HPD signal from the HDMI sink 120, the HDMI source 110 may recognize that an HDMI connection to the HDMI sink 120 is established and may read the EDID information of the HDMI sink 120 so as to be assigned with a physical address using the EDID information.

The HDMI source 110 may perform a logical address discovery process defined by the HDMI CEC standard so as to be assigned with a logical address.

A control device 100 performs the function of the CP described above with reference to FIG. 1, and may detect and control the HDMI source 110 and the HDMI sink 120.

That is, the HDMI source 110 and the HDMI sink 120 may be controlled by the control device 100 so as to transmit/receive data through an IP-based interface such as “Ethernet”, “USB”, “802.11”, “HSDPA”, “HomePNA”, “HomePlug”, “MoCA”, “G.hn” or “UPA” defined by the UPnP standard, or may transmit/receive content through the HDMI.

Here, a device having content may be defined as a UPnP media server (MS) or a DLNA digital media server (DMS), and the HDMI source 110 having an HDMI output may be defined as a UPnP media renderer (MR) or a DLNA digital media renderer (DMR), more specifically, a UPnP decoding MR or a DLNA decoding DMR. The HDMI sink 120 having an HDMI input may be defined as a UPnP MR or a DLNA DMR, more specifically, a UPnP displaying MR or a DLNA displaying DMR.

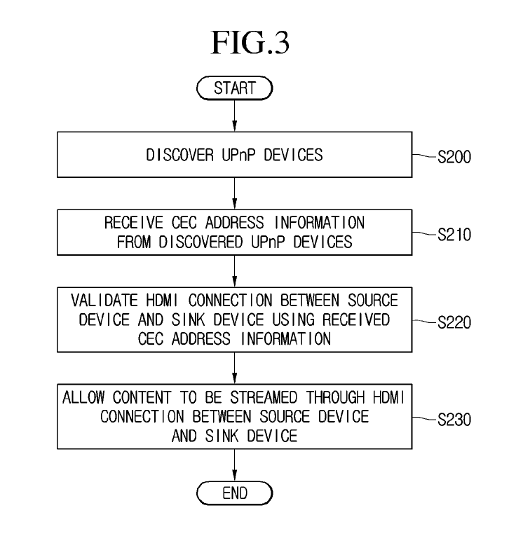

FIG. 3 is a flowchart illustrating a content transmission/reception control method according to an embodiment. The control method will be described in connection with the block diagram of FIG. 2.

Referring to FIG. 3, the control device 100 discovers a plurality of UPnP devices (operation S200), and receives CEC information from the discovered UPnP devices (operation S210).

For example, the HDMI source 110 and the HDMI sink 120 connected to a UPnP/DLNA network may be automatically discovered by the control device 100 through the discovery process described above with reference to FIG. 1.

The discovered devices may be connected to or differentiated from each other using IP addresses and universally unique IDs (UUIDs). Accordingly, the control device 100 may detect a map and a topology of a network according to the IP-based interface using the IP addresses and UUIDs.

The HDMI source 110 and the HDMI sink 120 connected to each other through the HDMI may be automatically discovered and assigned with a CEC address, i.e., a physical address and a logical address, as described above with reference to FIG. 2.

In operation S210, the control device 100 may transmit, to each UPnP device discovered using the UPnP discovery protocol, a UPnP message for requesting transmission of CEC address information using an IP address of each UPnP device.

Accordingly, the control device 100 may receive the CEC address information from the HDMI source 110 and the HDMI sink 120, wherein the CEC address information may include a CEC address of a corresponding device and a CEC address of a device connected to the corresponding device through the HDMI.

Thereafter, the control device 100 validates an HDMI connection between the source device and the sink device using the received CEC addresses (operation S220), and allows content to be streamed through the HDMI connection between the source device and the sink device (operation S230).

For example, the control device 100 may identify which ones of the discovered UPnP devices are connected to each other through the HDMI, using the CEC address information received in operation S210, i.e., the CEC address of each UPnP device and the CEC addresses of devices connected thereto. Accordingly, the control device 100 may detect that the HDMI source 110 and the HDMI sink 120 are connected to each other through the HDMI.

In operation S230, the control device 100 may manage the HDMI connection between the HDMI source 110 and the HDMI sink 120 and may control the content streaming through the HDMI connection. In addition, the control device 100 may allow the content streaming to be relayed through another device.

Although it has been described that the control device 100 requests and receives the CEC address information from the discovered devices, the present disclosure is not limited thereto. For example, in the UPnP discovery process described above with reference to FIG. 1, each device may transfer its CEC address and a CEC address of a device connected thereto to the control device 100.

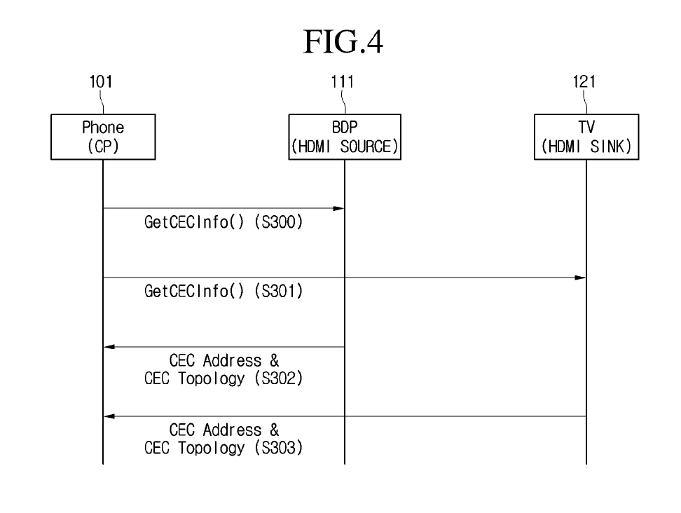

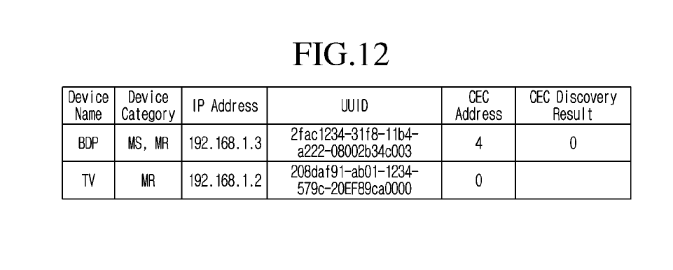

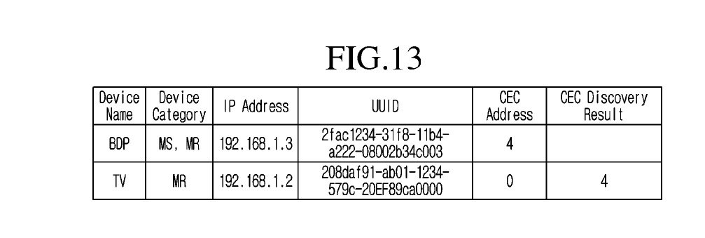

Hereinafter, a method for receiving, by the control device 100, the CEC address information of the discovered UPnP devices, according to an embodiment, will be described in detail with reference to FIGS. 4 to 13.

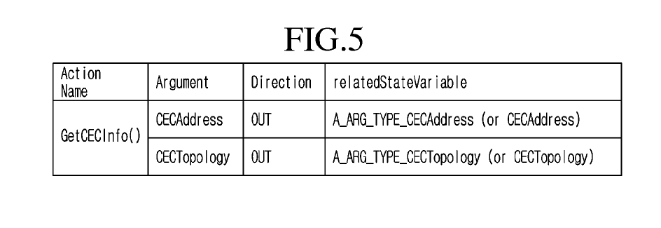

Referring to FIGS. 4 and 5, a GetCECInfo( ) action and a state variable related thereto may be newly defined in order for the control device 100 to request the CEC address information from devices discovered by the UPnP discovery protocol.

With respect to each discovered UPnP device, the control device 100 may call the GetCECInfo( ) so as to receive CEC topology information indicating whether a corresponding device supports the HDMI protocol, the CEC address of the corresponding device discovered by the CEC discovery protocol, and the CEC address of a device connected to the corresponding device.

In detail, the state variable of the GetCECInfo( ) action may include CECAddress and CECTopology, wherein the CECAddress may represent the CEC address of a discovered device and the CECTopology may represent the CEC address of a device connected to the discovered device through the HDMI.

When the control device 100 calls the GetCECInfo( ) action, the discovered UPnP devices may report the CECAddress and the CECTopology as output arguments of the action.

For example, a phone 101 that is a control point (CP) calls the GetCECInfo( ) action (operation S300, operation S301), a bluray disk player (BDP) 111 and a TV 121 that are UPnP devices connected through the HDMI hand over CECAddress and CECTopology state variables as output arguments so as to report, to the phone 101, their CEC addresses and CEC addresses of devices connected to them (e.g., CEC topology information) (operation S302, operation S303).

The control point, i.e., the phone 101, may check the CEC addresses and CEC topology of the BDP 111 that is an HDMI source and the TV 121 that is an HDMI sink, and thus may recognize that the BDP 111 and the TV 121 are connected to each other through the HDMI.

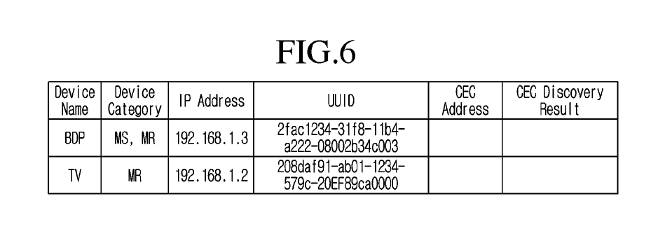

FIGS. 6 to 13 are diagrams illustrating examples of device discovery result information obtained by the control device 100 through the above-mentioned discovery processes and CEC address information request process. The discovery result information may include a device category, an IP address, a UUID, a CEC address and a CEC discovery result (i.e., CEC topology information) of each discovered UPnP device.

Referring to FIG. 6, in the case where the BDP 111 and the TV 121 do not support an HDMI/CEC protocol, the CEC addresses and CEC topology information of the BDP 111 and the TV 121 are not handed over to the phone 101 as state variables for the GetCECInfor( ) action.

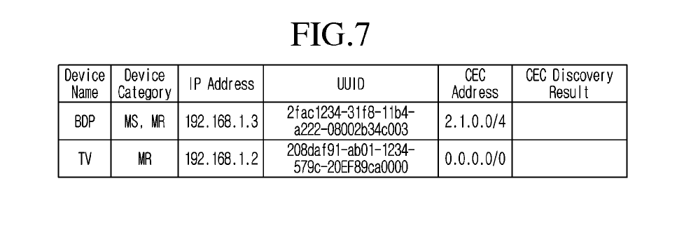

Referring to FIG. 7, in the case where the BDP 111 and the TV 121 support the HDMI/CEC protocol but are not connected to each other, the CEC addresses of the BDP 111 and the TV 121 are handed over to the phone 101 as state variables for the GetCECInfor( ) action, but the CEC topology information is not reported to the phone 101.

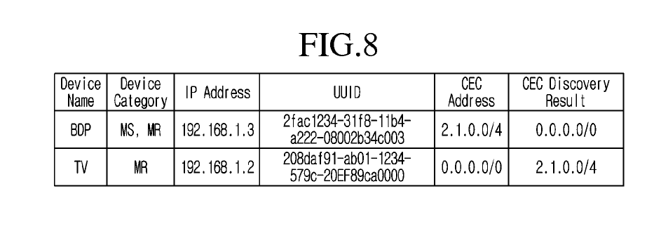

Referring to FIG. 8, in the case where the BDP 111 and the TV 121 support the HDMI/CEC protocol and are connected to each other, the CEC addresses and CEC topology information of the BDP 111 and the TV 121 are handed over to the phone 101 as state variables for the GetCECInfor( ) action.

In this case, the CEC topology information of the BDP 111 represents “0.0.0.0/0” that is the CEC address of the TV 121, and the CEC topology information of the TV 121 represents “2.1.0.0/4” that is the CEC address of the BDP 111, so that the control point, i.e., the phone 101, may recognize that the BDP 111 and the TV 121 are connected to each other through the HDMI.

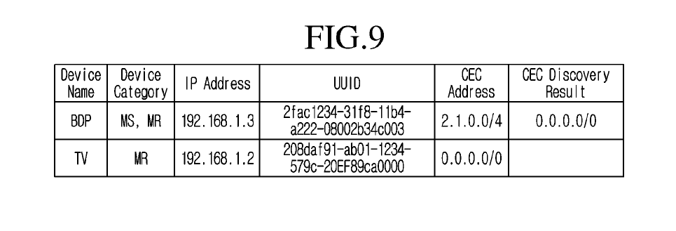

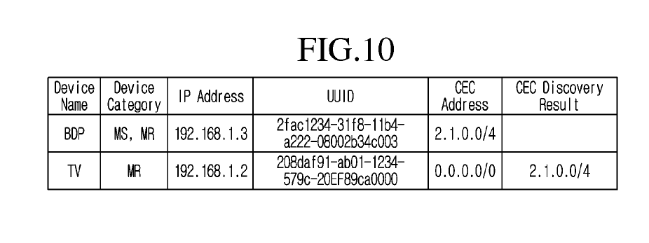

Referring to FIGS. 9 and 10, only one of an HDMI source and an HDMI sink may hand over the CEC topology information to the control device 100 as a state variable for the GetCECInfo( ) action.

For examples, as illustrated in FIG. 9, only the BDP 111 that is an HDMI source may report the CEC topology information to the phone 101 that is a control point, or, as illustrated in FIG. 10, only the TV 111 that is ah HDMI sink (or, a root or a media renderer (MR)) may report the CEC information to the phone 101.

Even in this case, the control point, i.e., the phone 101, may detect that the BDP 111 and the TV 121 are connected to each other through the HDMI/CEC, on the basis of only one piece of CEC topology information.

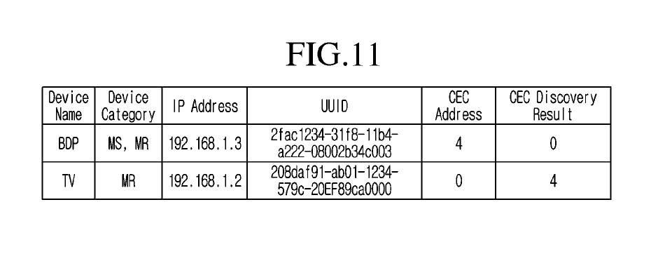

Furthermore, referring to FIGS. 11 to 13, since devices may be differentiated from each other by logical addresses alone, the CEC address information, i.e., the CEC address and the CEC topology may include a logical address alone.

The DLNA technology defines a 2-box model and a 3-box model.

The 2-box model includes a DMP and a DMS. In the 2-box model, the DMP enables a user to search for and play content advertised and distributed by the DMS.

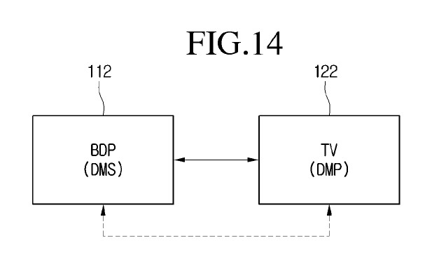

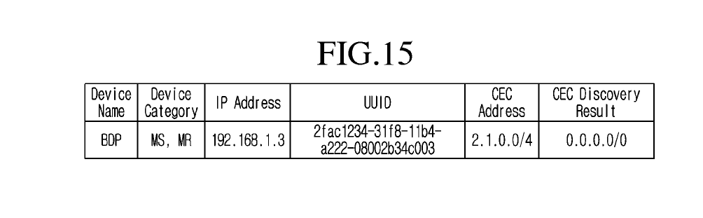

Referring to FIGS. 14 and 15, in the case where the BDP 112 that is a DMS and the TV 122 that is a DMP are connected to each other through the HDMI, the TV 122 may obtain the IP address, UUID, CEC address and CEC topology of the BDP 112 through the above-mentioned discovery process.

The TV 122 may ascertain that the CEC topology information of the BDP 112 includes the CEC address of the TV 122, i.e., “0.0.0.0/0”, and may recognize that the TV 122 is connected to the BDP 112, to which a CEC address of “2.1.0.0/4” is assigned, using the HDMI/CEC protocol.

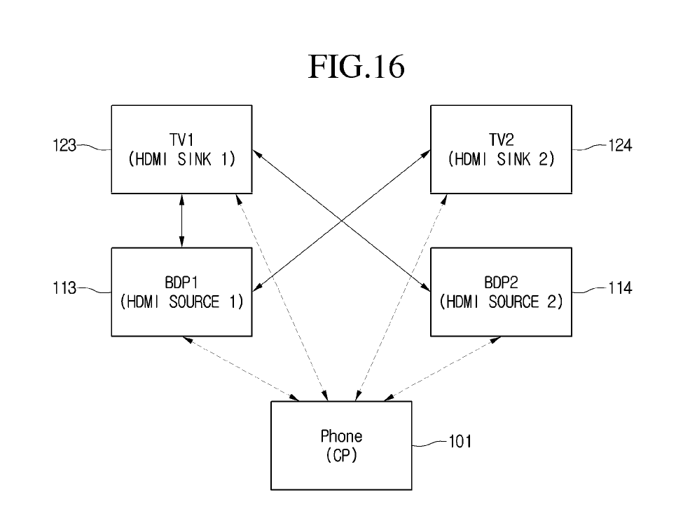

FIG. 16 is a block diagram illustrating a content transmitting/receiving system according to another embodiment. The system may include a plurality of source devices and sink devices connected to each other through the HDMI.

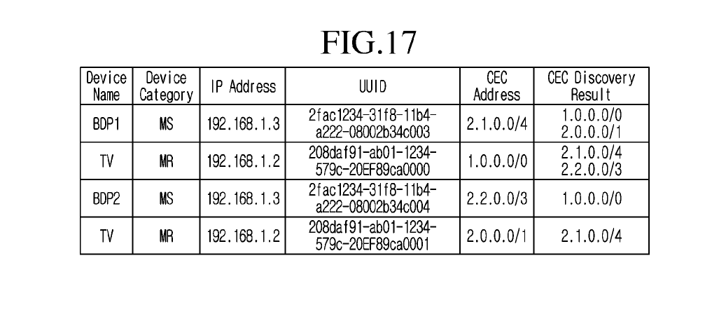

In this case, the control point, i.e., the phone 101, may obtain, through the above-mentioned discovery process, IP addresses, UUIDs, CEC addresses and CEC topology information of a BDP1 113, a TV1 123, a BDP2 114 and a TV2 124 which form a network, as illustrated in FIG. 17.

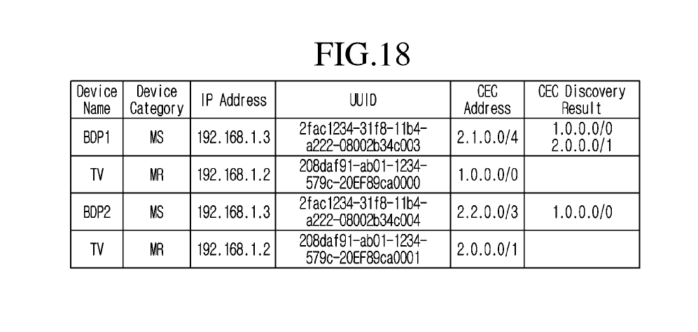

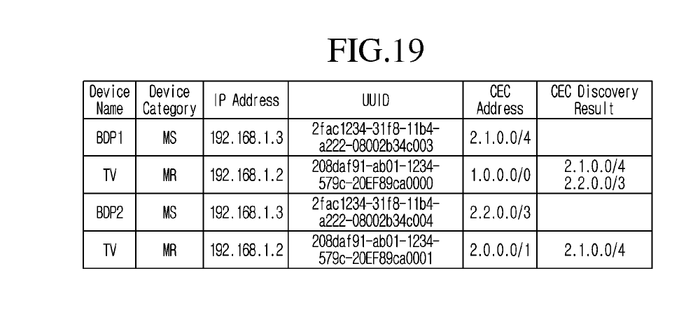

Referring to FIGS. 18 and 19, only one of an HDMI source and an HDMI sink, e.g., the BDP1 113 and BDP2 114 or the TV1 123 and TV2 124, may report the CEC topology information to the control point, i.e., the phone 101.

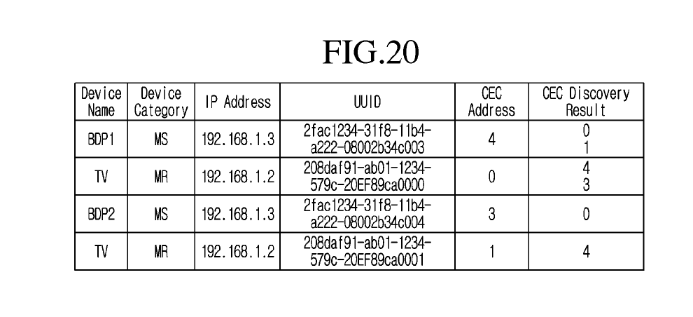

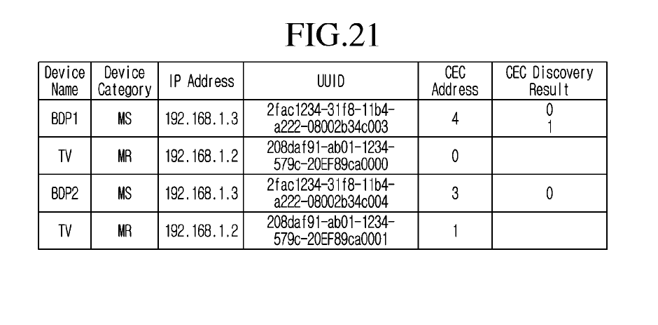

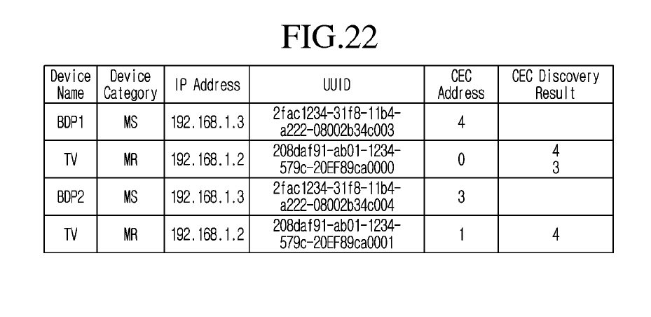

Furthermore, as illustrated in FIGS. 20 to 22, the CEC address and CEC topology of each discovered device may include only a logical address assigned thereto.

According to another embodiment, the control device 100 may request CEC address information of discovered UPnP devices using an existing action defined in the UPnP standard.

For example, the control device 100 may request the CEC address information of UPnP devices using a Browse/Search( ) action or a GetProtocolInfo( ) action defined in a ContentDirectory service and a ConnectionManager service of the UPnP standard.

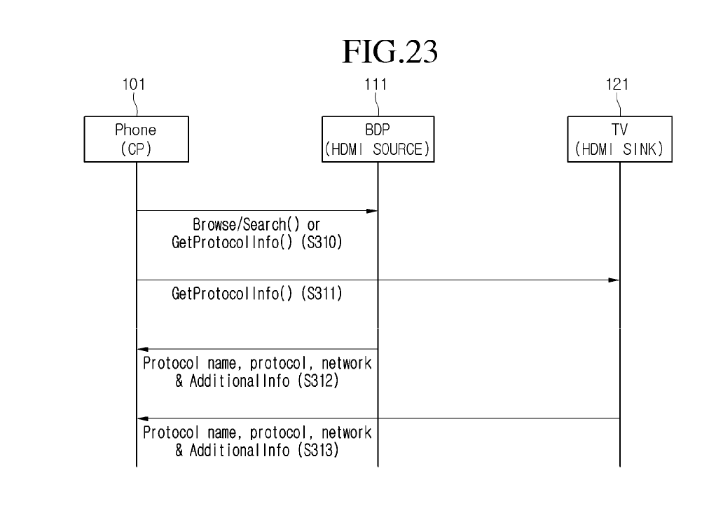

FIG. 23 is a ladder diagram illustrating a second example of a method for receiving CEC address information of UPnP devices.

Referring to FIG. 23, the control point, i.e., the phone 101, calls the Browse/Search( ) or GetProtocolInfor( ) action (operation S310, operation S311), and receives, as a response to the action, a protocol name, a protocol, a network and additional information AdditionalInfo from the BDP 111 and the TV 121 (operation S312, operation S313).

In detail, with respect to the BDP 111 that is a media server, the control point, i.e., the phone 101, may call the Browse/Search( ) action to obtain res@protocolInfo as a CDS property, or may call the GetProtocolInfo( ) action to receive a report on SourceProtocolInfo and SinkProtocolInfo state variables as output arguments.

With respect to the TV 112 that is a media renderer, the control point, i.e., the phone 101, may call the GetProtocolInfo( ) action to receive a report on SourceProtocolInfo and SinkProtocolInfo state variables as output arguments.

It may be required to add the HDMI protocol to definitions of ProtocolInfo and values thereof so that CEC address information is reported using the Browse/Search( ) or GetProtocolInfo( ) action.

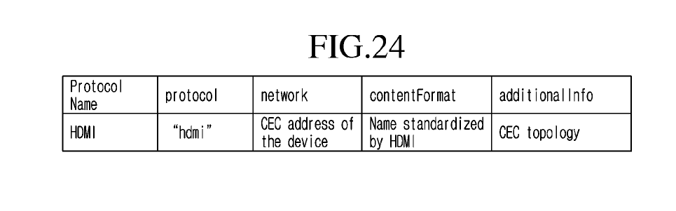

Referring to FIG. 24, the ProtocolInfo and values thereof added with respect to the HDMI protocol may have a protocol name of “HDMI”, a protocol of “hdmi”, a networking including a CEC address of a corresponding device, contentFormat including a name standardized by the HDMI, and additionalInfo including CEC topology information.

The contentFormat may exist only for a media server (MS), and may be filled in the case where content to be played by the media server can be decoded in a non-compressed file format defined by the HDMI.

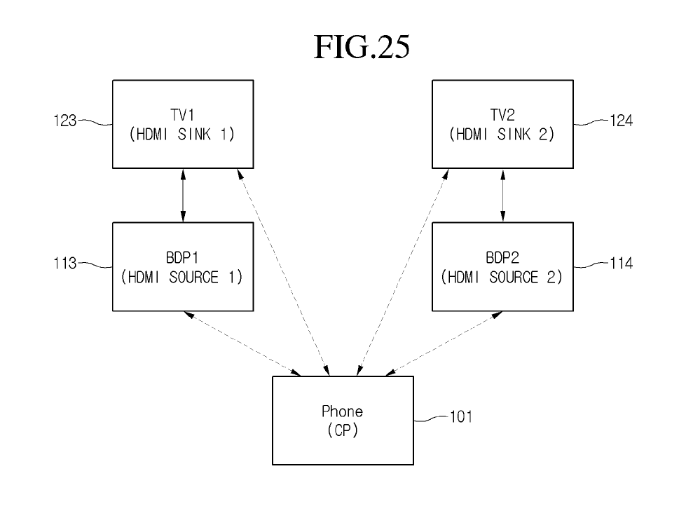

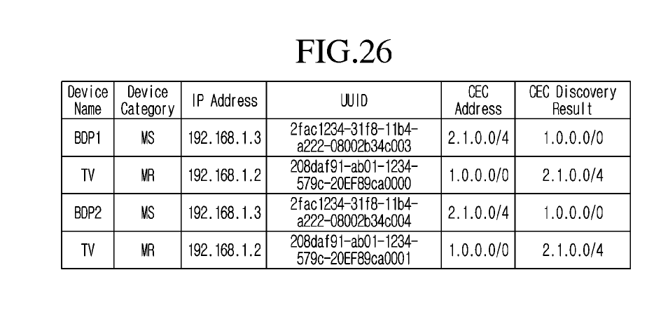

FIGS. 25 and 26 are diagrams illustrating an example of a method for validating an HDMI connection between a source device and a sink device. The example is a specific example of the HDMI connection validation method performed in operation S220 of FIG. 3.

Referring to FIG. 25, the BDP1 113 and the BDP2 114 may be respectively connected to the TV1 123 and TV2 124 through the HDMI so as to form independent HDMI networks respectively.

As illustrated in FIG. 26, the BDP1 113 and the BDP2 114 may have identical CEC addresses, and the TV1 123 and the TV2 124 may have identical CEC addresses. In this case, the control point, i.e., the phone 101, may regard the BDP1 113 and the BDP2 114 as being connected to the TV2 124 and the TV1 123 respectively, wherein the BDP1 113 and the BDP2 114 are not actually connected to the TV2 124 and the TV1 123.

In order to prevent such an error, the control point, i.e., the phone 101, may re-validate the HDMI connection recognized using the CEC address information.

For example, in the case where the control device 100 transmits a connection confirmation request message to any one of the HDMI source and the HDMI sink recognized as being connected to each other on the basis of the CEC address information, and a response to the connection confirmation request message is received from the other one, it may be confirmed that the two devices are connected to each other through the HDMI.

For example, when the phone 101 transmits the connection confirmation request message to the BDP1 113, the message is transferred to the TV1 123 through an HDMI cable, and the phone 101 receives a response to the connection confirmation request message from the TV1 123, so that the phone 101 may ascertain that the BDP1 113 is connected to the TV1 123 through the HDMI but is not connected to the TV2 124.

After the control device 100 validates the HDMI connection between UPnP devices as described above, the control device 100 may turn on/off an HDMI session between the HDMI source 110 and the HDMI sink 120 so as to manage the HDMI connection.

For example, the control device 100 that is a control point transmits, to at least one of the HDMI source 110 and the HDMI sink 120, a UPnP control message for turning on/off the HDMI session between the HDMI source 110 and the HDMI sink 120, so as to allow a CEC message corresponding to the UPnP control message to be transmitted/received through the HDMI connection between the HDMI source 110 and the HDMI sink 120, thereby managing the HDMI connection.

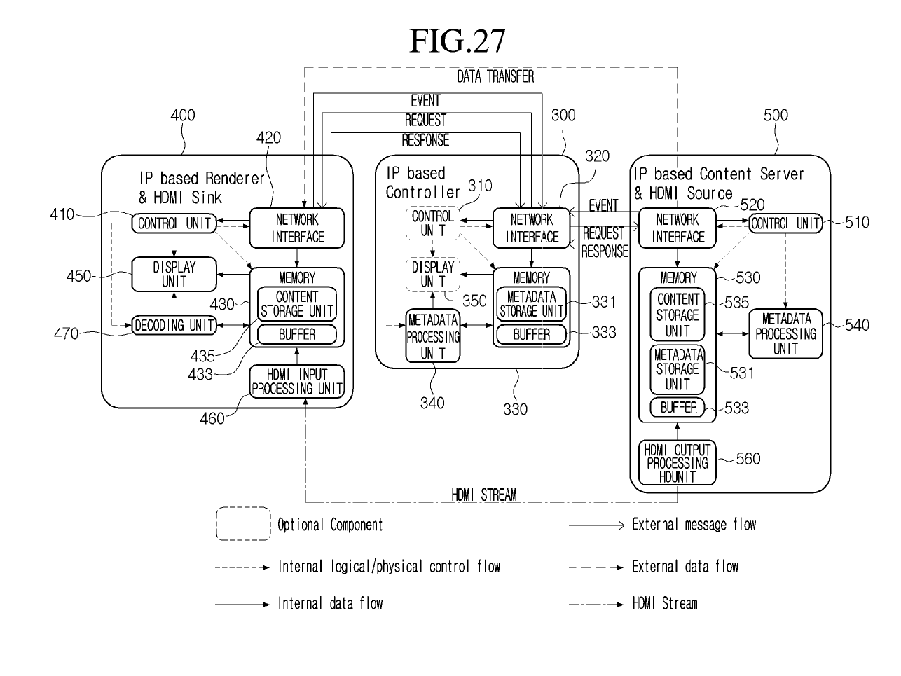

A scheme for identifying, by the phone 101 that is a control point, devices connected to each other through the HDMI in the case where devices having identical CEC address information exist in the same network will be described in more detail with reference to FIGS. 27 to 53.

In order to enable an HDMI media service through the UPnP/DLNA protocol, the phone 101 that is a control point may be required to detect whether devices are connected to each other through the HDMI on the basis of the UPnP/DLNA protocol. The control point may detect the HDMI connection between devices on the basis of the CEC addresses and CEC topology information assigned to the devices.

However, the UPnP/DLNA uses an IP-based addressing scheme, and the HDMI uses a CEC-based addressing scheme. Since an IP network and a CEC network do not exchange information with each other, it is unable to validate the HDMI connection between devices on the basis of the UPnP/DLNA protocol.

As described above, each device transfers its CEC address and CEC topology information using the UPnP/DLNA protocol, and the UPnP/DLNA protocol allows the information to be shared between devices so that it is detected whether an HDMI connection is established. According to such a scheme, no error occurs in the case where some of UPnP/DLNA devices that form a single IP network connected to a single access point form a single HDMI network. However, in the case where UPnP/DLNA devices that form a single IP network connected to a single access point form multiple independent HDMI networks, devices that belong to different HDMI networks may be assigned with identical CEC addresses. Therefore, a plurality of devices having identical CEC addresses may be detected using the UPnP/DLNA protocol. In this case, the control point is unable to surely determine whether devices are connected to each other.

For example, in the case where devices A and B form a single HDMI network and devices C and D form another separate HDMI network, if the devices A and C have identical CEC addresses, the control point is unable to determine whether the device B is HDMI-connected to the device A and whether the device B is HDMI-connected to the device C.

A 2-box model and a 3-box model according to an embodiment will be described to describe the scheme for identifying, by the phone 101 that is a control point, devices connected to each other through the HDMI in the case where devices having identical CEC address information exist in the same network.

FIG. 27 is a block diagram illustrating the 3-box model according to an embodiment.

As illustrated in FIG. 27, the 3-box model according to an embodiment includes an IP-based controller 300, an IP-based renderer 400, and an IP-based content server 500.

The IP-based controller 300 has a function of a CP of the UPnP and/or a function of a DMC of the DLNA.

The IP-based controller 300 sends a message serving as a command, a request or an action to various devices such as a server and a renderer. The IP-based controller 300 may transmit such a message according to a user input, or may transmit such a message autonomously without the user input. The IP-based controller 300 may support a user interface for transferring, to a user, a response received from the other-party device after sending the message. The IP-based controller 300 may support such a user interface using a built-in display unit, or may support the UI using a display device of a third party.

The IP-based renderer 400 includes a function of an HDMI sink, and includes a function of a DMR of the DLNA and/or a function of a control target device of the UPnP. The IP-based renderer 400 is a control target device that receives, from the IP-based controller 300, the message serving as a command, a request or an action. In general, the IP-based renderer 400, which represents a device capable of playing media content, receives and plays media content from the IP-based content server 500, and supports a trick mode (play, stop, pause, fast forward, rewind, etc.).

The IP-based content server 500 includes a function of an HDMI source, and includes a function of a DMS of the DLNA and/or a function of a control target device of the UPnP.

The IP-based server 500 is a control target device that receives, from the IP-based controller 300, a message of a command, a request or an action. In general, the IP-based content server 500 represents a device for storing media content, and provides metadata of the media content to another control target device or the IP-based controller 300 so that information on the media content is checked and various media services such as streaming, uploading and downloading are provided.

The IP-based controller 300 includes a control unit 310, a network interface 320, a memory 330, a metadata processing unit 340, and a display unit 350.

The control unit 310 is a main agent for performing all operations of the IP-based controller 300 described herein.

The network interface 320 supports transmission/reception of IP-based messages through an IP-based network.

The memory 330 stores various types of information and state variables which will be described later.

In particular, the memory 330 includes metadata, content, a metadata storage unit 331, and a buffer 333. The metadata storage unit 331 includes metadata of pieces of content. The buffer 333 temporarily stores various types of data.

The metadata processing unit 340 processes and displays received metadata.

The display unit 350 displays processed information. For example, the display unit 350 may include at least one of a liquid crystal display (LCD), a thin film transistor-liquid crystal display (TFT LCD), an organic light-emitting diode (OLED), a flexible display, and a 3D display.

The IP-based renderer 400 includes a control unit 410, a network interface 420, a memory 430, a display unit 450, an HDMI input processing unit 460, and a decoding unit 470.

The control unit 410 is a main agent for performing all operations of the IP-based renderer 400 described herein.

The network interface 420 supports transmission/reception of IP-based messages through an IP-based network.

The memory 430 stores metadata, content, various types of information and state variables which will be described later. In particular, the memory 430 includes a content storage unit 435 and a buffer 433. The content storage unit 435 stores media content data. The buffer 433 temporarily stores various types of data.

The display unit 450 displays processed information. For example, the display unit 450 may include at least one of a liquid crystal display (LCD), a thin film transistor-liquid crystal display (TFT LCD), an organic light-emitting diode (OLED), a flexible display, and a 3D display.

The HDMI input processing unit 460 processes uncompressed media content received through an HDMI connection.

The decoding unit 470 decodes encoded media content.

The IP-based content server 500 includes a control unit 510, a network interface 520, a memory 530, a metadata processing unit 540, and an HDMI output processing unit 560.

The control unit 510 is a main agent for performing all operations of the IP-based content server 500 described herein.

The network interface 520 supports transmission/reception of IP-based messages through an IP-based network.

The memory 530 stores metadata, content, various types of information and state variables which will be described later. In particular, the memory 533 includes a metadata storage unit 531, a buffer 533, and a content storage unit 535. The metadata storage unit 531 includes metadata of pieces of media content. The buffer 533 temporarily stores various types of data. The content storage unit 535 stores media content data.

The metadata processing unit 540 extracts and classifies metadata of stored content.

The HDMI output processing unit 560 transmits uncompressed media content through an HDMI connection.

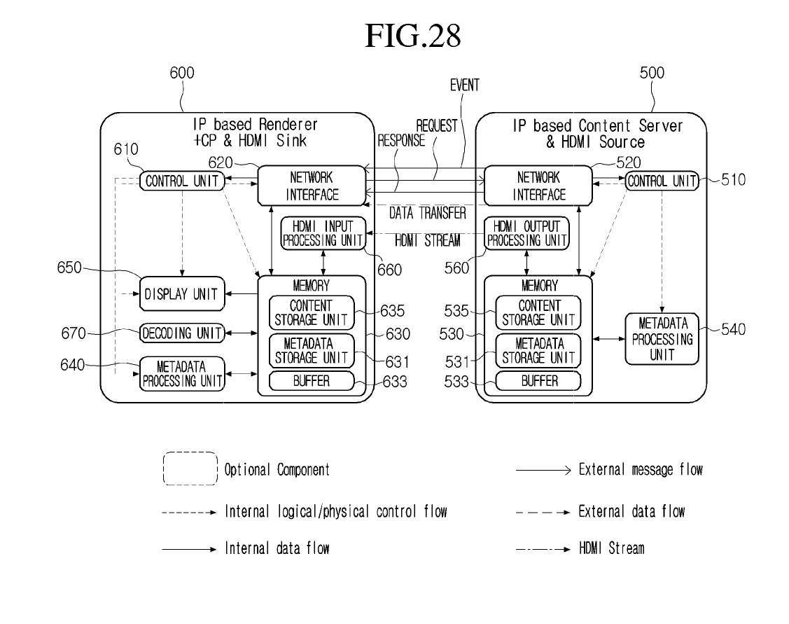

FIG. 28 is a block diagram illustrating the 2-box model according to an embodiment.

As illustrated in FIG. 28, the 2-box model according to an embodiment includes an IP-based renderer 600 and an IP-based content server 500 operating as an HDMI source.

The IP-based renderer 600 includes a function of a CP of the UPnP and/or a function of a DMC of the DLNA, and includes a function of an HDMI sink.

The IP-based content server 500 includes a function of an HDMI source, and includes a function of a DMS of the DLNA and/or a function of a control target device of the UPnP.

The IP-based renderer 600 includes a control unit 610, a network interface 620, a memory 630, a metadata processing unit 640, a display unit 650, an HDMI input processing unit 660, and a decoding unit 670.

The control unit 610 is a main agent for performing all operations of the IP-based renderer 600 described herein.

The network interface 620 supports transmission/reception of IP-based messages through an IP-based network.

The memory 630 stores metadata, content, various types of information and state variables which will be described later. In particular, the memory 630 includes a metadata storage unit 631, a buffer 633, and a content storage unit 635. The metadata storage unit 631 includes metadata of pieces of media content. The buffer 633 temporarily stores various types of data. The content storage unit 635 stores media content data.

The metadata processing unit 640 processes and displays received metadata.

The display unit 650 displays processed information. For example, the display unit 650 may include at least one of a liquid crystal display (LCD), a thin film transistor-liquid crystal display (TFT LCD), an organic light-emitting diode (OLED), a flexible display, and a 3D display.

The HDMI input processing unit 660 processes uncompressed media content received through an HDMI connection.

The decoding unit 670 decodes encoded media content.

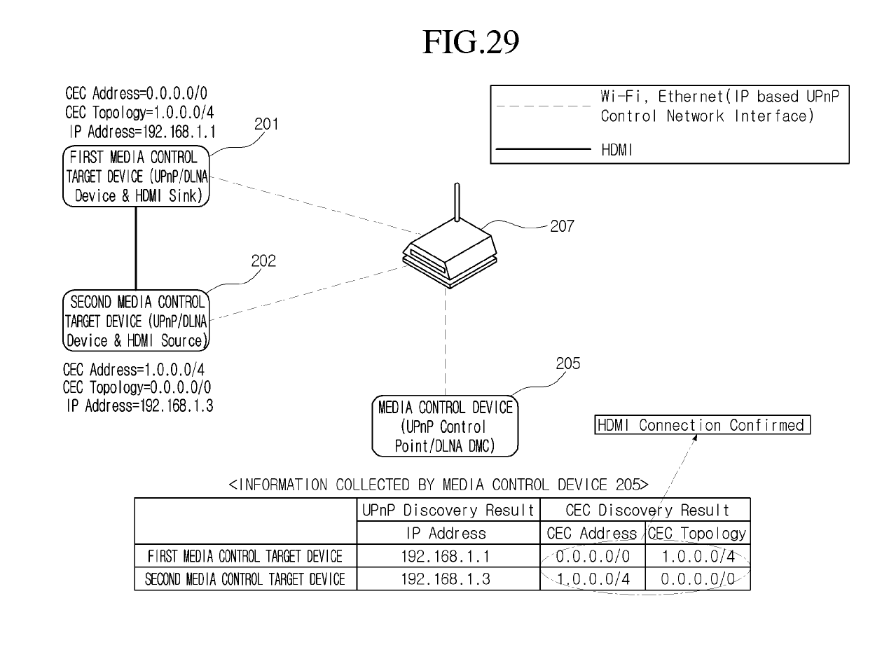

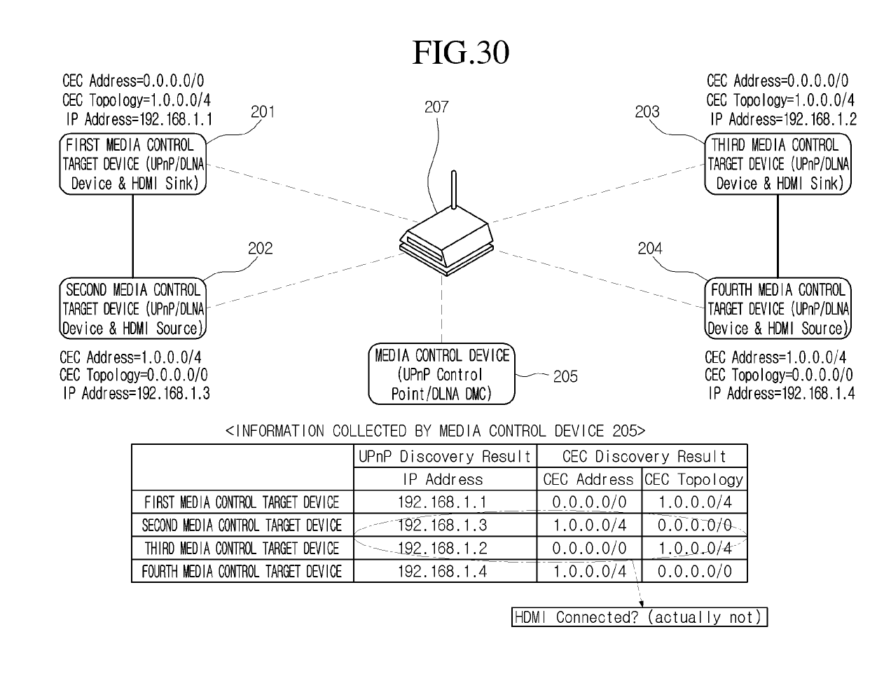

An HDMI connection validating method according to an embodiment will be described with reference to FIGS. 29 and 30.

FIG. 29 is a diagram illustrating a network topology of an HDMI connection validating method according to an embodiment.

Referring to FIG. 29, the network topology includes a first media control target device 201, a second media target device 202, a media control device 205, and an access point 207.

In FIG. 29, it is assumed that the first media control target device 201, the second media control target device 202, a third media control target device 203, a fourth media control target device 204, and the media control device 205 comply with both a home network protocol and a CEC protocol. The term “home network protocol” used herein covers the concept of the DLNA and UPnP.

The media control device 205 may correspond to a DMC or DMP of the DLNA, or a CP device of the UPnP.

In FIG. 29, it is assumed that the first media control target device 201, the second media target device 202, and the media control device 205 are connected to the same access point 207 so as to belong to the same IP-based network.

In FIG. 29, it is assumed that the first media control target device 201 is connected to the second media control target device 202 through a first HDMI connection so that the first media control target device 201 and the second media control target device 202 belong to a first CEC-based network.

In FIG. 29, it is assumed that the first media control target device 201 corresponds to an HDMI sink and has a CEC address of 0.0.0.0/0 and an IP address of 192.168.1.1, and a CEC address of a device directly connected thereto through an HDMI is 1.0.0.0/4.

It is assumed that the second media control target device 202 corresponds to an HDMI source and has a CEC address of 1.0.0.0/4 and an IP address of 192.168.1.3, and a CEC address of a device directly connected thereto through an HDMI is 0.0.0.0/0.

Herein, the CEC topology represents a CEC address of a device directly connected through an HDMI.

In FIG. 29, a thick solid line represents an HDMI connection, and a thin dotted line represents an IP-based home network interface connection. The IP-based home network interface connection may be at least one of Wi-Fi and Ethernet.

As illustrated in FIG. 29, the media control device 205 discovers a plurality of media control target devices that are a plurality of home network devices (operation S200 of FIG. 3), and, when CEC address information is received from the discovered home network devices (operation S210 of FIG. 3), the media control device 205 may ascertain that the first media control target device 201 is connected to the second media control target device 202 through the HDMI connection, on the basis of information on a CEC address and information on a CEC topology.

FIG. 30 is a diagram illustrating a network topology of an HDMI connection validating method according to an embodiment.

Referring to FIG. 30, the network topology includes the first media control target device 201, the second media control target device 202, the third media control target device 203, the fourth media control target device 204, the media control device 205, and the access point 207.

In FIG. 30, it is assumed that the first media control target device 201, the second media control target device 202, the third media control target device 203, the fourth media control target device 204, and the media control device 205 comply with both the home network protocol and the CEC protocol.

In FIG. 30, it is assumed that the first media control target device 201, the second media control target device 202, the third media control target device 203, the fourth media control target device 204, and the media control device 205 are connected to the same access point 207 so as to belong to the same IP-based network.

In FIG. 30, it is assumed that the first media control target device 201 is connected to the second media control target device 202 through the first HDMI connection so that the first media control target device 201 and the second media control target device 202 belong to the first CEC-based network.

In FIG. 30, it is assumed that the third media control target device 203 is connected to the fourth media control target device 204 through a second HDMI connection different from the first HDMI connection so that the third media control target device 203 and the fourth media control target device 204 belong to a second CEC-based network different from the first CEC-based network.

It is assumed that the first media control target device 201 corresponds to an HDMI sink and has a CEC address of 0.0.0.0/0 and an IP address of 192.168.1.1, and a CEC address of a device directly connected thereto through the HDMI is 1.0.0.0/4.

It is assumed that the second media control target device 202 corresponds to an HDMI source and has a CEC address of 1.0.0.0/4 and an IP address of 192.168.1.3, and a CEC address of a device directly connected thereto through the HDMI is 0.0.0.0/0.

It is assumed that the third media control target device 203 corresponds to an HDMI sink and has a CEC address of 0.0.0.0/0 and an IP address of 192.168.1.2, and a CEC address of a device directly connected thereto through the HDMI is 1.0.0.0/4.

It is assumed that the fourth media control target device 204 corresponds to an HDMI source and has a CEC address of 1.0.0.0/4 and an IP address of 192.168.1.4, and a CEC address of a device directly connected thereto through the HDMI is 0.0.0.0/0.

The media control device 205 discovers a plurality of media control target devices that are a plurality of home network devices (operation S200 of FIG. 3), and receives CEC address information from the discovered home network devices (operation S210 of FIG. 3), so as to collect the information as illustrated in FIG. 30.

However, the CEC address of the device directly connected to the first media control target device 201 through the HDMI is 1.0.0.0/4, but the devices having the CEC address of 1.0.0.0/4 are the second media control target device 202 and the fourth media control target device 204. Therefore, the media control device 205 is unable to determine whether the first media control target device 201 is connected to the second control target device 202 through the HDMI or is connected to the fourth media control target device 204 through the HDMI, on the basis of the information on a CEC address and the information on a CEC topology.

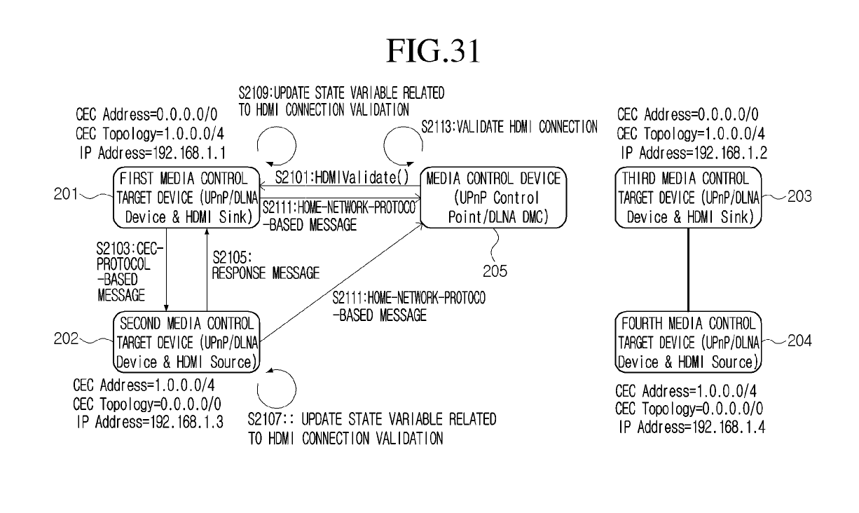

Therefore, a more improved HDMI connection validating method is required. An HDMI connection validating method based on an HDMI connection validation test message according to an embodiment will be described with reference to FIGS. 31 to 39.

FIG. 31 is a diagram illustrating a network topology of an HDMI connection validating method based on an HDMI connection validation test message according to an embodiment.

Referring to FIG. 31, the network topology includes the first media control target device 201, the second media control target device 202, the third media control target device 203, the fourth media control target device 204, and the media control device 205.

In FIG. 31, it is assumed that the first media control target device 201, the second media control target device 202, the third media control target device 203, and the fourth media control target device 204 comply with both the home network protocol and the CEC protocol. The term “home network protocol” used herein covers the concept of the DLNA and UPnP.

The media control device 205 may correspond to a DMC or DMP of the DLNA, or a CP device of the UPnP.

In FIG. 31, it is assumed that the first media control target device 201, the second media control target device 202, the third media control target device 203, the fourth media control target device 204, and the media control device 205 are connected to the same access point 207 so as to belong to the same IP-based network.

In FIG. 31, it is assumed that the first media control target device 201 is connected to the second media control target device 202 through the first HDMI connection so that the first media control target device 201 and the second media control target device 202 belong to the first CEC-based network.

In FIG. 31, it is assumed that the third media control target device 203 is connected to the fourth media control target device 204 through the second HDMI connection different from the first HDMI connection so that the third media control target device 203 and the fourth media control target device 204 belong to the second CEC-based network different from the first CEC-based network.

It is assumed that the first media control target device 201 corresponds to an HDMI sink and has a CEC address of 0.0.0.0/0 and an IP address of 192.168.1.1, and a CEC address of a device directly connected thereto through the HDMI is 1.0.0.0/4.

It is assumed that the second media control target device 202 corresponds to an HDMI source and has a CEC address of 1.0.0.0/4 and an IP address of 192.168.1.3, and a CEC address of a device directly connected thereto through the HDMI is 0.0.0.0/0.

It is assumed that the third media control target device 203 corresponds to an HDMI sink and has a CEC address of 0.0.0.0/0 and an IP address of 192.168.1.2, and a CEC address of a device directly connected thereto through the HDMI is 1.0.0.0/4.

It is assumed that the fourth media control target device 204 corresponds to an HDMI source and has a CEC address of 1.0.0.0/4 and an IP address of 192.168.1.4, and a CEC address of a device directly connected thereto through the HDMI is 0.0.0.0/0.

The media control device 205 discovers a plurality of media control target devices that are a plurality of home network devices (operation S200 of FIG. 3), and receives CEC address information from the discovered home network devices (operation S210 of FIG. 3).

The media control device 205 transmits an HDMI connection validation message based on the home network protocol to the first media control target device 201 corresponding to an HDMI connection validation target device, through the IP-based home network (operation S2101). Here, the media control device 205 may store a time at which the HDMI connection validation message is transmitted. The HDMI connection validation message may include or may not include the CEC address of an HDMI connection validation target device different from the first media control target device 201.

Herein, the HDMI connection validation message based on the home network protocol is represented by an HDMIValidate( ) action.

In one embodiment, the HDMI connection validation message may be a message of a request for sending, to a device connected through the HDMI, a CEC-protocol-based HDMI connection validation test message for validating an HDMI connection via the CEC-based network. Here, the test message for validating an HDMI connection may be a ping message or a poll message based on the CEC protocol.

In another embodiment, the HDMI connection validation message may be a message of a request for sending, to a device connected through the HDMI, a CEC-protocol-based identifier report message via the CEC-based network. Here, the identifier report message may include an identifier of the first media control target device 201. The identifier of the first media control target device 201 may be the IP address of the first media control target device 201 or a home-network-protocol-based unique device name (UDN) of the first media control target device 201.

In another embodiment, the HDMI connection validation message may be a message of a request for sending, to a device connected through the HDMI, a CEC-protocol-based identifier request message via the CEC-based network. When the first media control target device 201 receives the home-network-protocol-based HDMI connection validation message, the first media control target device 201 transmits, through the CEC-based network, a CEC-protocol-based message to the second media control target device 202 connected thereto through the HDMI (operation S2103).

In the case where the HDMI connection validation message includes the CEC address of an HDMI connection validation target device different from the first media control target device 201, the first media control target device 201 may transmit a CEC-protocol-based message to a media control target device corresponding to the CEC address.

In the case where the HDMI connection validation message does not include the CEC address of the HDMI connection validation target device different from the first media control target device 201, the first media control target device 201 may transmit the CEC-protocol-based message to all devices connected thereto through the HDMI.

In one embodiment, in the case where the HDMI connection validation message is the message of the request for sending the CEC-protocol-based test message for validating an HDMI connection, the first media control target device 201 may transmit, to the second media control target device 202 connected thereto through the HDMI, the test message through the CEC-based network.

In another embodiment, in the case where the HDMI connection validation message is the message of the request for sending the identifier report message, the first media control target device 201 may transmit, to the second media control target device 202 connected thereto through the HDMI, the CEC-protocol-based identifier report message through the CEC-based network. Here, the identifier report message may include the identifier of the first media control target device 201.

In another embodiment, in the case where the HDMI connection validation message is the message of the request for sending the identifier request message, the first media control target device 201 may transmit, to the second media control target device 202 connected thereto through the HDMI, the CEC-protocol-based identifier request message through the CEC-based network.

When the first media control target device 201 validates a connection to another media control target device through the HDMI without receiving the home-network-protocol-based HDMI connection validation message, the first media control target device 201 may transmit, to the second media control target device 202 connected thereto through the HDMI, the CEC-protocol-based message through the CEC-based network.

In the case where the first media control target device 201 transmits, to the second media control target device 202 connected thereto through the HDMI, the CEC-protocol-based message through the CEC-based network, the second media control target device 202 transmits a message of response to the received message to the first media control target device 201 through the CEC-based network (operation S2105). Here, the response message is based on the CEC protocol.

In one embodiment, in the case where the first media control target device 201 transmits, to the second media control target device 202, the CEC-protocol-based test message for validating an HDMI connection, the second media control target device 202 may transmit, to the first media control target device 201, a CEC-protocol-based ACK message for acknowledging successful receipt of the test message.

In another embodiment, in the case where the first media control target device 201 transmits, to the second media control target device 202, the CEC-protocol-based identifier report message, the second media control target device 202 may transmit, to the first media control target device 201, a CEC-protocol-based ACK message for acknowledging successful receipt of the identifier report message. In the case where the first media control target device 201 transmits, to the second media control target device 202, the CEC-protocol-based identifier report message, the second media control target device 202 may not transmit, to the first media control target device 201, a message of response to the identifier report message.

In another embodiment, in the case where the first media control target device 201 transmits, to the second media control target device 202, the CEC-protocol-based identifier request message, the second media control target device 202 may transmit, to the first media control target device 201, the CEC-protocol-based identifier report message as a response to the identifier request message.

Thereafter, the second media control target device 202 updates a state variable related to HDMI connection validation (operation S2107).

In one embodiment, in the case where the first media control target device 201 transmits, to the second media control target device 202, the CEC-protocol-based test message for validating an HDMI connection, the second media control target device 202 may update LastCECValidatedTime that is a state variable about a last HDMI connection validation time. Here, the state variable for the last HDMI connection validation time may represent a state variable for recording a time related to the reception of the CEC-protocol-based test message for validating an HDMI connection. The time related to the reception of the CEC-protocol-based test message may represent a time at which the CEC-protocol-based test message for validating an HDMI connection is received or a time at which the ACK message for the CEC-protocol-based test message is transmitted.

In another embodiment, in the case where the first media control target device 201 transmits, to the second media control target device 202, the CEC-protocol-based identifier report message, the second media control target device 202 may update, on the basis of the identifier report message, a state variable for recording a list of identifiers of devices connected to the second media control target device 202 through the HDMI. If the first media control target device 201 has previously transmitted, to the second media control target device 202, the CEC-protocol-based identifier report message, and the second media control target device 202 has updated the state variable for the identifier list, the state variable for the identifier list may not be changed in spite of current reception of the identifier report message.

The first media control target device 201 update a state variable related to HDMI connection validation (operation S2109).

In the case where the second media control target device 202 transmits, to the first media control target device 201, the CEC-protocol-based identifier report message, the first media control target device 201 may update, on the basis of the identifier report message, a state variable for recording a list of identifiers of devices connected to the first media control target device 201 through the HDMI.

Thereafter, the media control device 205 receives an HDMI connection information message based on the home network protocol from the first media control target device 201 or the second media control target device 202, via the IP-based home network (operation S2111). Here, the connection information message based on the home network protocol may include an updated state variable as described above.

Although described later, the HDMI connection information message may be one of a home-network-protocol-based ACK message, a home-network-protocol-based event message including information on a last HDMI connection validation time, a home-network-protocol-based response message including information on a last HDMI connection validation time, a home-network-protocol-based connection information message including the identifier of the first media control target device 201, a home-network-protocol-based event message including a state variable for a list of identifiers, and a home-network-protocol-based connection information response message including a state variable for a list of identifiers.

In one embodiment, in the case where the first media control target device 201 transmits, to the second media control target device 202, the CEC-protocol-based test message for validating an HDMI connection, the second media control target device 202 may transmit the home-network-protocol-based ACK message to the media control device 205.

In another embodiment, in the case where the first media control target device 201 transmits, to the second media control target device 202, the CEC-protocol-based test message for validating an HDMI connection, the second media control target device 202 may update a state variable about a last HDMI connection validation time. When the state variable for the last HDMI connection validation time is changed by the updating, the second media control target device 202 may transmit, to the media control device 205, information on the last HDMI connection validation time, although the media control device 205 does not request the last HDMI connection validation time. When the state variable for the last HDMI connection validation time is changed by the updating and the second media control target device 202 receives a message of requesting the last HDMI connection validation time from the media control device 205, the second media control target device 202 may transmit, to the media control device 205, the information on the last HDMI connection validation time. Here, the message of requesting the last HDMI connection validation time is based on the home network protocol.

In another embodiment, in the case where the first media control target device 201 transmits, to the second media control target device 202, the CEC-protocol-based identifier report message, the second media control target device 202 may update a state variable for recording a list of identifiers of devices connected to the second media control target device 202 through the HDMI. When the state variable for recording the list of identifiers of devices connected to the second media control target device 202 through the HDMI is changed by the updating, the second media control target device 202 may transmit, to the media control device 205, information on the list of identifiers, although the media control device 205 does not request the list of identifiers. When the state variable for the list of identifiers is changed by the updating and the second media control target device 202 receives a message of requesting the list of identifiers from the media control device 205, the second media control target device 202 may transmit, to the media control device 205, the information on the list of identifiers. Here, the message of requesting the list of identifiers is based on the home network protocol.

In another embodiment, in the case where the second media control target device 202 transmits, to the first media control target device 201, the CEC-protocol-based identifier report message, the first media control target device 201 may update a state variable for recording a list of identifiers of devices connected to the first media control target device 201 through the HDMI. The first media control target device 201 may transmit as a response to the home-network-protocol-based HDMI connection validation message information on the list of identifiers to the media control device 205. When the state variable for recording the list of identifiers of devices connected to the first media control target device 201 through the HDMI is changed by the updating, the first media control target device 201 may transmit, to the media control device 205, the information on the list of identifiers, although the media control device 205 does not request the list of identifiers. When the state variable for the list of identifiers is changed by the updating and the first media control target device 201 receives a message of requesting the list of identifiers from the media control device 205, the first media control target device 201 may transmit, to the media control device 205, the information on the list of identifiers.

The media control device 205 validates an HDMI connection on the basis of the received message (operation S2113). The media control device 205 may identify, on the basis of the received message, a device connected to the first media control target device 201 through the HDMI.

In the case where the HDMI connection validation message includes the CEC address of an HDMI connection validation target device different from the first media control target device 201, the media control device 205 may ascertain, on the basis of the received message, that the first media control target device 201 is connected to a media control target device corresponding to the CEC address through the HDMI.

In the case where the HDMI connection validation message does not include the CEC address of an HDMI connection validation target device different from the first media control target device 201, the media control device 205 may check a list of devices connected to the first media control target device 201 through the HDMI.

In one embodiment, in the case where the second media control target device 202 transmits the home-network-protocol-based ACK message to the media control device 205, the media control device 205 may ascertain that the first media control target device 201 that has received the home-network-protocol-based HDMI connection validation message is connected, through the HDMI, to the second media control target device 202 that has transmitted the home-network-protocol-based ACK message. In the case where a difference between a time at which the home-network-protocol-based HDMI connection validation message is transmitted to the first media control target device 201 and a time at which the home-network-protocol-based ACK message is received from the second media control target device 202 is within a reference value, the media control device 205 may ascertain that the first media control target device 201 that has received the home-network-protocol-based HDMI connection validation message is connected, through the HDMI, to the second media control target device 202 that has transmitted the home-network-protocol-based ACK message.

In another embodiment, in the case where the second media control target device 202 transmits, to the media control device 205, information on a last HDMI connection validation time, the media control device 205 may validate an HDMI connection on the basis of the information on the last HDMI connection validation time. In detail, in the case where a difference between a time at which the home-network-protocol-based HDMI connection validation message is transmitted to the first media control target device 201 and the last HDMI connection validation time is within a reference value, the media control device 205 may ascertain that the first media control target device 201 that has received the home-network-protocol-based HDMI connection validation message is connected, through the HDMI, to the second media control target device 202 that has transmitted the information on the last HDMI connection validation time.

In another embodiment, in the case where the second media control target device 202 transmits, to the media control device 205, information on a list of identifiers, the media control device 205 may validate an HDMI connection on the basis of the information on the list of identifiers. The media control device 205 may ascertain that at least one media control target device belonging to the list of identifiers is connected to the second media control target device 202 through the HDMI.

In another embodiment, in the case where the first media control target device 201 transmits, to the media control device 205, information on a list of identifiers, the media control device 205 may validate an HDMI connection on the basis of the information on the list of identifiers. The media control device 205 may ascertain that at least one media control target device belonging to the list of identifiers is connected to the first media control target device 201 through the HDMI.

In FIG. 31, it is assumed that the first media control target device 201 is an HDMI sink and the second media control target device 202 is an HDMI source. However, an embodiment may also be applied to the case where the first media control target device 201 is an HDMI source and the second media control target device 202 is an HDMI sink.

Thereafter, media control device 205 allows content to be streamed through the HDMI connection between the HDMI source device and the HDMI sink device (operation S230 of FIG. 3).

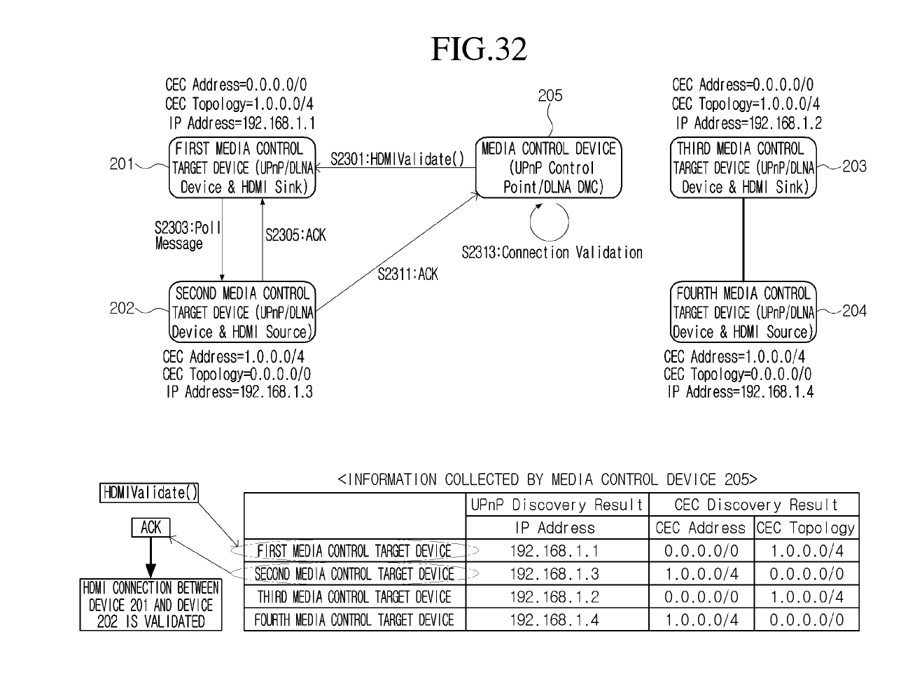

The HDMI connection validating method based on an HDMI connection validation test message according to an embodiment will be described in detail with reference to FIGS. 32 to 39.

FIG. 32 is a diagram illustrating a network topology of an HDMI connection validating method based on an HDMI connection validation test message according to an embodiment.

It is assumed that the network topology of FIG. 32 is the same as the network topology of FIG. 31.

The media control device 205 transmits the HDMI connection validation message based on the home network protocol to the first media control target device 201 corresponding to an HDMI connection validation target device, via the IP-based home network (operation S2301). Here, the media control device 205 may store a time at which the HDMI connection validation message is transmitted. The HDMI connection validation message may include or may not include the CEC address of an HDMI connection validation target device different from the first media control target device 201. Here, the HDMI connection validation message is a message of a request for sending, to a device connected through the HDMI, a CEC-protocol-based HDMI connection validation test message for validating an HDMI connection via the CEC-based network.

When the first media control target device 201 receives the home-network-protocol-based HDMI connection validation message, the first media control target device 201 transmits, through the CEC-based network, the CEC-protocol-based HDMI connection validation test message to the second media control target device 202 connected thereto through the HDMI (operation S2303).

In the case where the HDMI connection validation message includes the CEC address of an HDMI connection validation target device different from the first media control target device 201, the first media control target device 201 may transmit the HDMI connection validation test message to a media control target device corresponding to the CEC address.

In the case where the HDMI connection validation message does not include the CEC address of an HDMI connection validation target device different from the first media control target device 201, the first media control target device 201 may transmit the HDMI connection validation test message to all devices connected thereto through the HDMI.

When the first media control target device 201 validates a connection to another media control target device through the HDMI without receiving the home-network-protocol-based HDMI connection validation message, the first media control target device 201 may transmit, to the second media control target device 202 connected thereto through the HDMI, the HDMI connection validation test message through the CEC-based network.

In the case where the first media control target device 201 transmits, to the second media control target device 202 connected thereto through the HDMI, the HDMI connection validation test message, the second media control target device 202 transmits a CEC-protocol-based ACK message for acknowledging successful receipt of the HDMI connection validation test message to the first media control target device 201 through the CEC-based network (operation S2305).

Thereafter, the second media control target device 202 transmits, to the media control device 205, a home-network-protocol-based ACK message for acknowledging successful receipt of the HDMI connection validation test message through the IP-based home network (operation S2311).

The media control device 205 validates an HDMI connection on the basis of the received ACK message (operation S2313). The media control device 205 may identify, on the basis of the received ACK message, a device connected to the first media control target device 201 through the HDMI. In detail, the media control device 205 may ascertain that the first media control target device 201 that has received the home-network-protocol-based HDMI connection validation message and the second media control target device 202 that has transmitted the home-network-protocol-based ACK message are connected to each other through the HDMI. In the case where a difference between a time at which the home-network-protocol-based HDMI connection validation message is transmitted to the first media control target device 201 and a time at which the home-network-protocol-based ACK message is received from the second media control target device 202 is within a reference value, the media control device 205 may ascertain that the first media control target device 201 that has received the home-network-protocol-based HDMI connection validation message is connected, through the HDMI, to the second media control target device 202 that has transmitted the home-network-protocol-based ACK message.

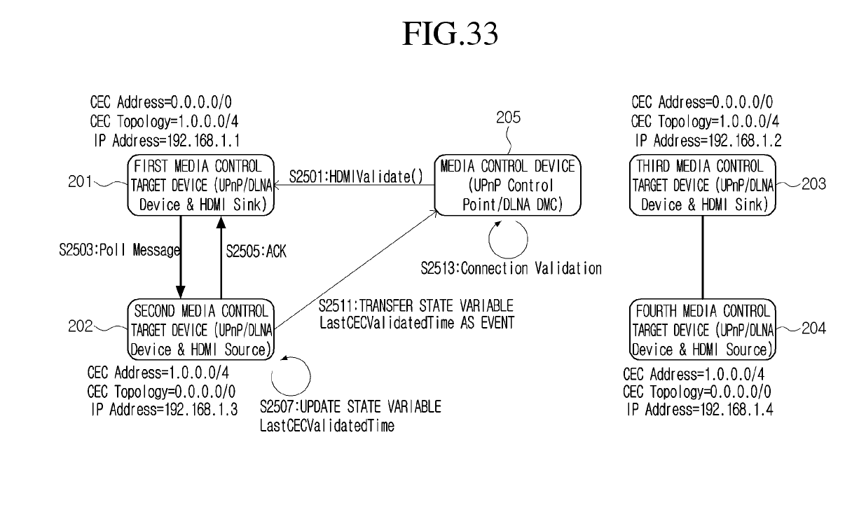

FIG. 33 is a diagram illustrating a network topology of an HDMI connection validating method based on an HDMI connection validation test message according to another embodiment.

It is assumed that the network topology of FIG. 33 is the same as the network topology of FIG. 31.

The media control device 205 transmits an HDMI connection validation message based on the home network protocol to the first media control target device 201 corresponding to an HDMI connection validation target device, via the IP-based home network (operation S2501). Here, the media control device 205 may store a time at which the HDMI connection validation message is transmitted. The HDMI connection validation message may include or may not include the CEC address of an HDMI connection validation target device different from the first media control target device 201. In the embodiment of FIG. 33, the HDMI connection validation message is a message of a request for sending, to a device connected through the HDMI, a CEC-protocol-based test message for validating an HDMI connection via the CEC-based network.

When the first media control target device 201 receives the home-network-protocol-based HDMI connection validation message, the first media control target device 201 transmits, via the CEC-based network, the CEC-protocol-based HDMI connection validation test message to the second media control target device 202 connected thereto through the HDMI (operation S2503).

In the case where the first media control target device 201 transmits, to the second media control target device 202 connected thereto through the HDMI, the HDMI connection validation test message via the CEC-based network, the second media control target device 202 transmits, via the CEC-based network, a CEC-protocol-based ACK message for acknowledging successful receipt of the HDMI connection validation test message to the first media control target device 201 (operation S2505).

Thereafter, the second media control target device 202 updates LastCECValidatedTime that is a state variable about a last HDMI connection validation time (operation S2507).

When the state variable for the last HDMI connection validation time is changed by the updating, the second media control target device 202 transmits, to the media control device 205, a home-network-protocol-based event message including information on the last HDMI connection validation time via the IP-based home network, although the media control device 205 does not request the last HDMI connection validation time (operation S2511).

The media control device 205 validates an HDMI connection on the basis of the received event message (operation S2513). The media control device 205 may validate the HDMI connection on the basis of the received information on the last HDMI connection validation time. In detail, in the case where a difference between a time at which the home-network-protocol-based HDMI connection validation message is transmitted to the first media control target device 201 and the last HDMI connection validation time is within a reference value, the media control device 205 may ascertain that the first media control target device 201 that has received the home-network-protocol-based HDMI connection validation message is connected, through the HDMI, to the second media control target device 202 that has transmitted the information on the last HDMI connection validation time.

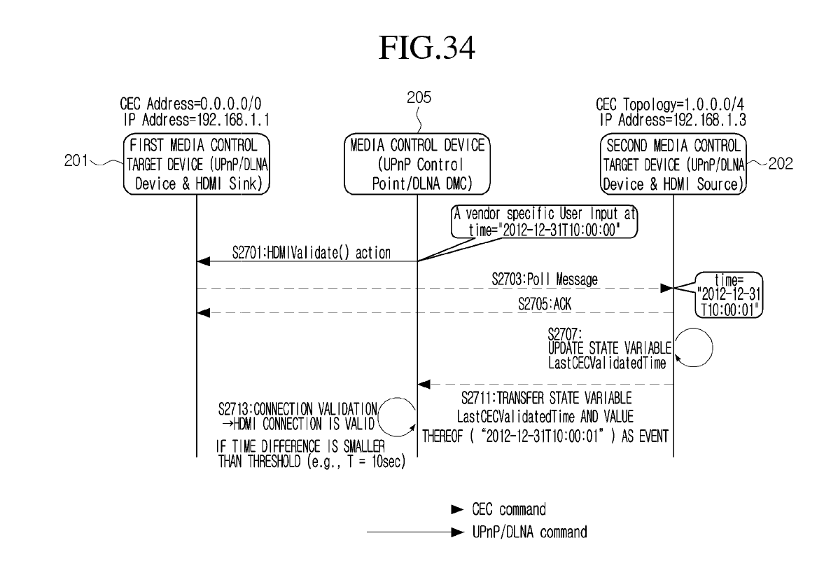

FIG. 34 is a diagram illustrating a network topology of an HDMI connection validating method based on an HDMI connection validation test message in a 3-box model according to an embodiment.

It is assumed that the network topology of FIG. 34 is the same as the network topology of FIG. 31.

The media control device 205 transmits an HDMI connection validation message based on the home network protocol to the first media control target device 201 corresponding to an HDMI connection validation target device, via the IP-based home network (operation S2701). Here, the media control device 205 may store a time at which the HDMI connection validation message is transmitted.

When the first media control target device 201 receives the home-network-protocol-based HDMI connection validation message, the first media control target device 201 transmits, via the CEC-based network, a CEC-protocol-based HDMI connection validation test message to the second media control target device 202 connected thereto through the HDMI (operation S2703).

In the case where the first media control target device 201 transmits, to the second media control target device 202 connected thereto through the HDMI, the HDMI connection validation test message via the CEC-based network, the second media control target device 202 transmits, via the CEC-based network, a CEC-protocol-based ACK message for acknowledging successful receipt of the HDMI connection validation test message to the first media control target device 201 (operation S2705).

Thereafter, the second media control target device 202 updates LastCECValidatedTime that is a state variable about a last HDMI connection validation time (operation S2707).

When the state variable for the last HDMI connection validation time is changed by the updating, the second media control target device 202 transmits, to the media control device 205, a home-network-protocol-based event message including information on the last HDMI connection validation time via the IP-based home network, although the media control device 205 does not request the last HDMI connection validation time (operation S2711).

The media control device 205 validates an HDMI connection on the basis of the received event message (operation S2713). The media control device 205 may validate the HDMI connection on the basis of the received information on the last HDMI connection validation time. In detail, in the case where a difference between a time at which the home-network-protocol-based HDMI connection validation message is transmitted to the first media control target device 201 and the last HDMI connection validation time is within a reference value, the media control device 205 may ascertain that the first media control target device 201 that has received the home-network-protocol-based HDMI connection validation message is connected, through the HDMI, to the second media control target device 202 that has transmitted the information on the last HDMI connection validation time.

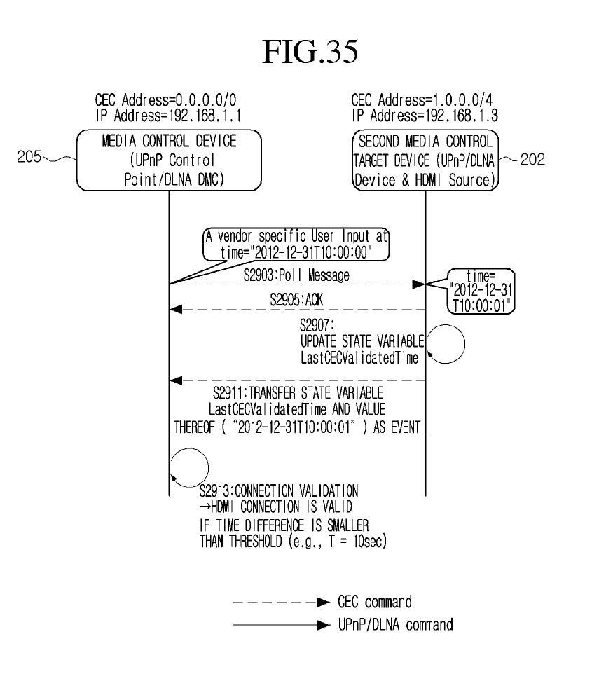

FIG. 35 is a diagram illustrating a network topology of an HDMI connection validating method based on an HDMI connection validation test message in a 2-box model according to an embodiment.

The network topology of FIG. 35 is similar to the network topology of FIG. 31, but it is assumed that the media control device 205 includes the function of the first media control target device 201. Therefore, unlike the network topology of FIG. 34, a home-network-protocol-based message between the media control device 205 and the first media control target device 201 is not used. However, provided that a module for performing the function of the media control device 205 and a module for performing the function of the first media control target device 201 are additionally implemented in the media control device 205, internal messages may be exchanged between the modules.

The media control device 205 transmits, via the CEC-based network, a CEC-protocol-based HDMI connection validation test message to the second media control target device 202 connected through the HDMI (operation S2903). Here, the media control device 205 may store a time at which the HDMI connection validation test message is transmitted.

In the case where the media control device 205 transmits, to the second media control target device 202 connected through the HDMI, the HDMI connection validation test message via the CEC-based network, the second media control target device 202 transmits, via the CEC-based network, a CEC-protocol-based ACK message for acknowledging successful receipt of the HDMI connection validation test message to the media control device 205 (operation S2905).

Thereafter, the second media control target device 202 updates LastCECValidatedTime that is a state variable about a last HDMI connection validation time (operation S2907).

When the state variable for the last HDMI connection validation time is changed by the updating, the second media control target device 202 transmits, to the media control device 205, a home-network-protocol-based event message including information on the last HDMI connection validation time via the IP-based home network, although the media control device 205 does not request the last HDMI connection validation time (operation S2911).

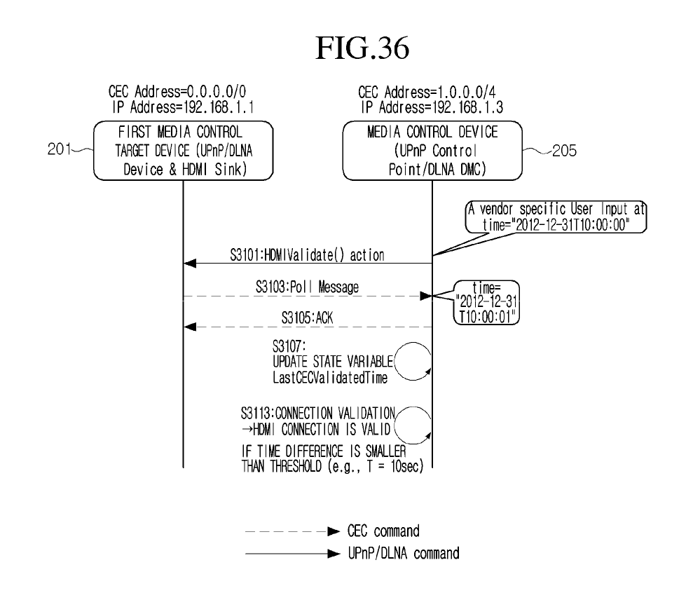

The media control device 205 validates an HDMI connection on the basis of the received event message (operation S2913). The media control device 205 may validate the HDMI connection on the basis of the received information on the last HDMI connection validation time. In detail, in the case where a difference between a time at which the CEC-protocol-based HDMI connection validation test message is transmitted to the second media control target device 201 and the last HDMI connection validation time is within a reference value, the media control device 205 may ascertain that the media control device 205 is connected to the second media control target device 202 through the HDMI. FIG. 36 is a diagram illustrating a network topology of an HDMI connection validating method based on an HDMI connection validation test message in a 2-box model according to an embodiment.

The network topology of FIG. 36 is similar to the network topology of FIG. 31, but it is assumed that the media control device 205 includes the function of the second media control target device 202. Therefore, unlike the network topology of FIG. 34, a home-network-protocol-based message between the media control device 205 and the second media control target device 202 is not used. However, provided that a module for performing the function of the media control device 205 and a module for performing the function of the second media control target device 202 are additionally implemented in the media control device 205, internal messages may be exchanged between the modules.

The media control device 205 transmits an HDMI connection validation message based on the home network protocol to the first media control target device 201 corresponding to an HDMI connection validation target device, via the IP-based home network (operation S3101). Here, the media control device 205 may store a time at which the HDMI connection validation message is transmitted.

When the first control target device 201 receives the home-network-protocol-based HDMI connection validation message, the first media control target device 201 transmits, via the CEC-based network, the CEC-protocol-based HDMI connection validation test message to the media control device 205 connected through the HDMI (operation S3103).

In the case where the first media control target device 201 transmits, to the media control device 205 connected thereto through the HDMI, the HDMI connection validation test message via the CEC-based network, the media control device 205 transmits, via the CEC-based network, a CEC-protocol-based ACK message for acknowledging successful receipt of the HDMI connection validation test message to the first media control target device 201 (operation S2705).

Thereafter, the media control device 205 updates LastCECValidatedTime that is a state variable about a last HDMI connection validation time (operation S3107).

The media control device 205 validates an HDMI connection (operation S3113). In detail, in the case where a difference between a time at which the home-network-protocol-based HDMI connection validation message is transmitted to the first media control target device 201 and the last HDMI connection validation time is within a reference value, the media control device 205 may ascertain that the media control device 205 is connected to the first media control target device 201 through the HDMI.

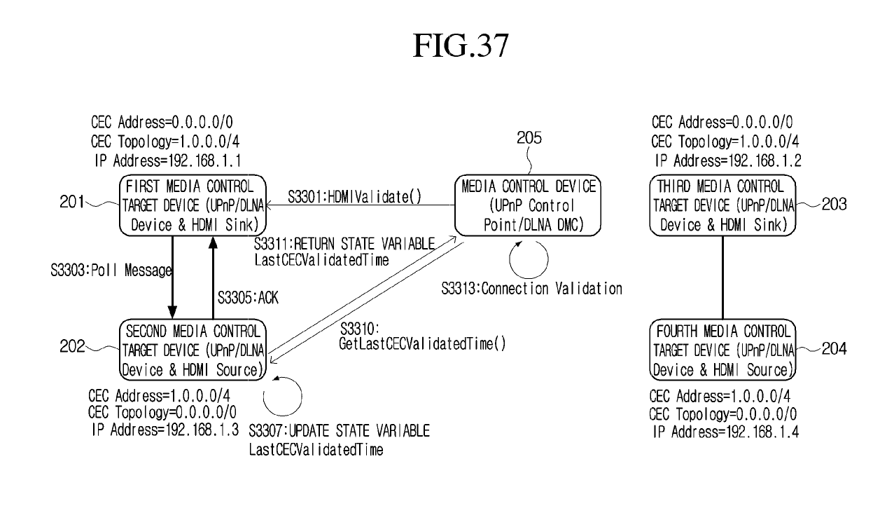

FIG. 37 is a diagram illustrating a network topology of an HDMI connection validating method based on an HDMI connection validation test message according to another embodiment.

It is assumed that the network topology of FIG. 37 is the same as the network topology of FIG. 31.

The media control device 205 transmits the HDMI connection validation message based on the home network protocol to the first media control target device 201 corresponding to an HDMI connection validation target device, via the IP-based home network (operation S3301). Here, the media control device 205 may store a time at which the HDMI connection validation message is transmitted. The HDMI connection validation message may include or may not include the CEC address of an HDMI connection validation target device different from the first media control target device 201. In the embodiment of FIG. 37, the HDMI connection validation message is a message of a request for sending, to a device connected through the HDMI, a CEC-protocol-based test message for validating an HDMI connection via the CEC-based network.

When the first control target device 201 receives the home-network-protocol-based HDMI connection validation message, the first media control target device 201 transmits, via the CEC-based network, the CEC-protocol-based HDMI connection validation test message to the second media control target device 202 connected thereto through the HDMI (operation S3303).

In the case where the first media control target device 201 transmits, to the second media control target device 202 connected thereto through the HDMI, the HDMI connection validation test message via the CEC-based network, the second media control target device 202 transmits, via the CEC-based network, a CEC-protocol-based ACK message for acknowledging successful receipt of the HDMI connection validation test message to the first media control target device 201 (operation S3305).

The second media control target device 202 updates LastCECValidatedTime that is a state variable about a last HDMI connection validation time (operation S3307).

Thereafter, the media control device 205 transmits, to the second media control target device 202, a request message for requesting the last HDMI connection validation time (operation S3310).

The second media control target device 202 transmits, to the media control device 205, a home-network-protocol-based response message including information on the last HDMI connection validation time via the IP-based home network (operation S3311).

The media control device 205 validates an HDMI connection on the basis of the received event message (operation S3313). The media control device 205 may validate the HDMI connection on the basis of the received information on the last HDMI connection validation time. In detail, in the case where a difference between a time at which the home-network-protocol-based HDMI connection validation message is transmitted to the first media control target device 201 and the last HDMI connection validation time is within a reference value, the media control device 205 may ascertain that the first media control target device 201 that has received the home-network-protocol-based HDMI connection validation message is connected, through the HDMI, to the second media control target device 202 that has transmitted the information on the last HDMI connection validation time.

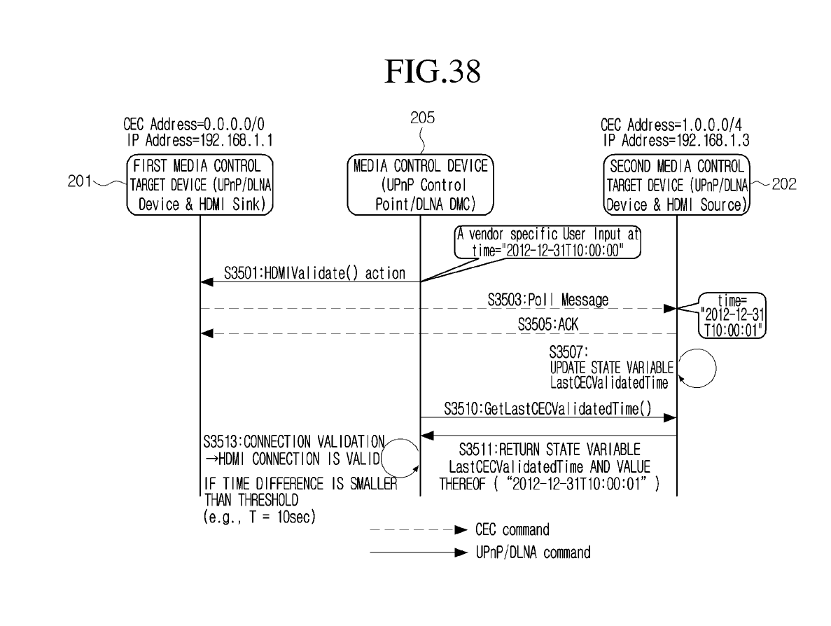

FIG. 38 is a diagram illustrating a network topology of an HDMI connection validating method based on an HDMI connection validation test message in a 3-box model according to another embodiment.

It is assumed that the network topology of FIG. 38 is the same as the network topology of FIG. 31.

The media control device 205 transmits the HDMI connection validation message based on the home network protocol to the first media control target device 201 corresponding to an HDMI connection validation target device, via the IP-based home network (operation S3501). Here, the media control device 205 may store a time at which the HDMI connection validation message is transmitted. In the embodiment of FIG. 38, the HDMI connection validation message is a message of a request for sending, to a device connected through the HDMI, a CEC-protocol-based test message for validating an HDMI connection via the CEC-based network.

When the first control target device 201 receives the home-network-protocol-based HDMI connection validation message, the first media control target device 201 transmits, via the CEC-based network, the CEC-protocol-based HDMI connection validation test message to the second media control target device 202 connected thereto through the HDMI (operation S3503).

In the case where the first media control target device 201 transmits, to the second media control target device 202 connected thereto through the HDMI, the HDMI connection validation test message via the CEC-based network, the second media control target device 202 transmits, via the CEC-based network, a CEC-protocol-based ACK message for acknowledging successful receipt of the HDMI connection validation test message to the first media control target device 201 (operation S3505).

The second media control target device 202 updates LastCECValidatedTime that is a state variable about a last HDMI connection validation time (operation S3507).

Thereafter, the media control device 205 transmits, to the second media control target device 202, a request message for requesting the last HDMI connection validation time (operation S3510).

The second media control target device 202 transmits, to the media control device 205, a home-network-protocol-based response message including information on the last HDMI connection validation time via the IP-based home network (operation S3511).

The media control device 205 validates an HDMI connection on the basis of the received event message (operation S3513). The media control device 205 may validate the HDMI connection on the basis of the received information on the last HDMI connection validation time. In detail, in the case where a difference between a time at which the home-network-protocol-based HDMI connection validation message is transmitted to the first media control target device 201 and the last HDMI connection validation time is within a reference value, the media control device 205 may ascertain that the first media control target device 201 that has received the home-network-protocol-based HDMI connection validation message is connected, through the HDMI, to the second media control target device 202 that has transmitted the information on the last HDMI connection validation time.

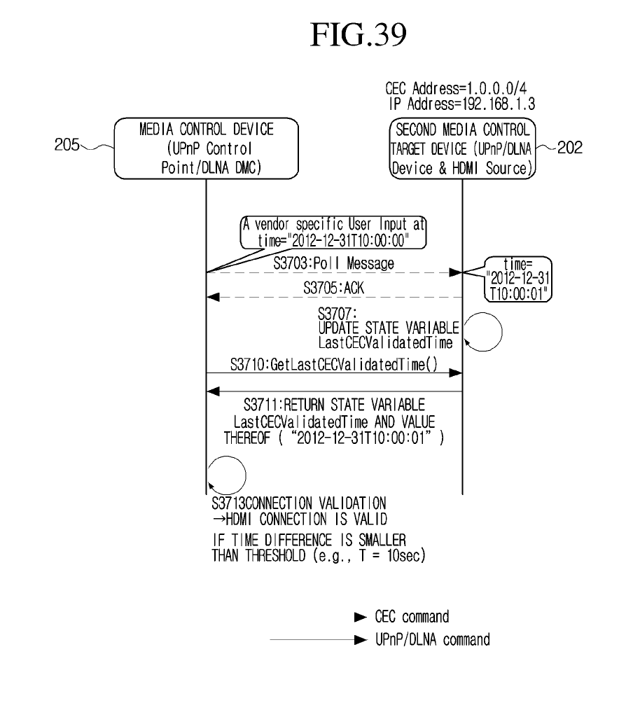

FIG. 39 is a diagram illustrating a network topology of an HDMI connection validating method based on an HDMI connection validation test message in a 3-box model according to another embodiment.

It is assumed that the network topology of FIG. 39 is the same as the network topology of FIG. 35.

The media control device 205 transmits, via the CEC-based network, a CEC-protocol-based HDMI connection validation test message to the second media control target device 202 connected through the HDMI (operation S3703). Here, the media control device 205 may store a time at which the HDMI connection validation test message is transmitted.

In the case where the media control device 205 transmits, to the second media control target device 202 connected through the HDMI, the HDMI connection validation test message via the CEC-based network, the second media control target device 202 transmits, via the CEC-based network, a CEC-protocol-based ACK message for acknowledging successful receipt of the HDMI connection validation test message to the media control device 205 (operation S3705).

Thereafter, the second media control target device 202 updates LastCECValidatedTime that is a state variable about a last HDMI connection validation time (operation S3707).

Thereafter, the media control device 205 transmits, to the second media control target device 202, a request message for requesting the last HDMI connection validation time (operation S3710).

The second media control target device 202 transmits, to the media control device 205, a home-network-protocol-based response message including information on the last HDMI connection validation time via the IP-based home network (operation S3711).

The media control device 205 validates an HDMI connection on the basis of the received event message (operation S3713). The media control device 205 may validate the HDMI connection on the basis of the received information on the last HDMI connection validation time. In detail, in the case where a difference between a time at which the CEC-protocol-based HDMI connection validation test message is transmitted to the second media control target device 201 and the last HDMI connection validation time is within a reference value, the media control device 205 may ascertain that the media control device 205 is connected to the second media control target device 202 through the HDMI.

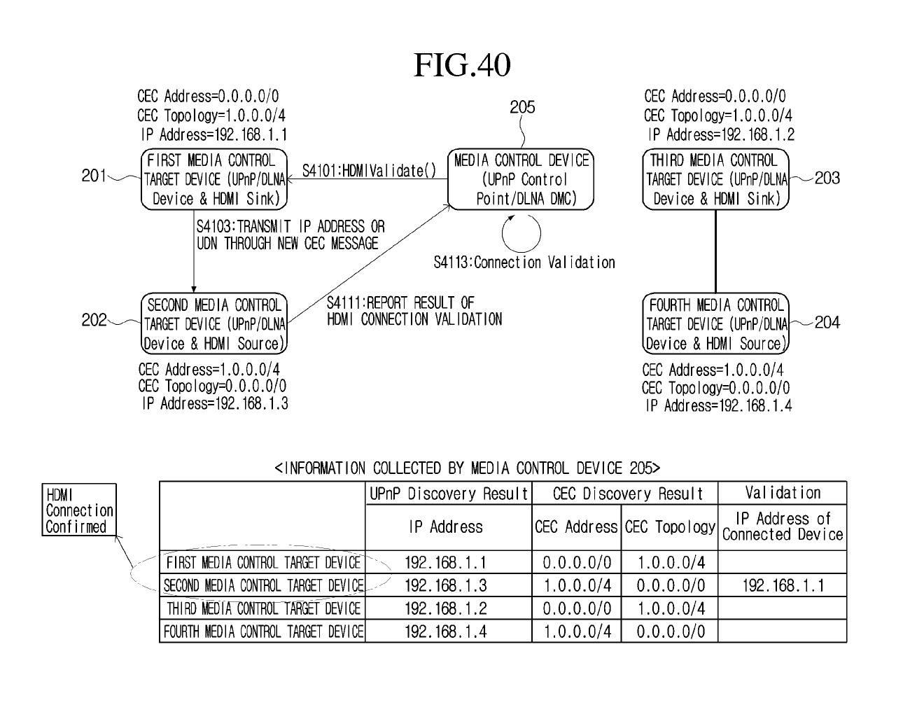

An identifier-based HDMI connection validating method according to an embodiment will be described with reference to FIGS. 40 to 53.

FIG. 40 is a diagram illustrating a network topology of the identifier-based HDMI connection validating method according to an embodiment.

It is assumed that the network topology of FIG. 40 is the same as the network topology of FIG. 31.

The media control device 205 transmits an HDMI connection validation message based on the home network protocol to the first media control target device 201 corresponding to an HDMI connection validation target device, via the IP-based home network (operation S4101). In the embodiment of FIG. 40, the HDMI connection validation message is a message of a request for sending, to a device connected through the HDMI, a CEC-protocol-based identifier report message via the CEC-based network.

When the first control target device 201 receives the home-network-protocol-based HDMI connection validation message, the first media control target device 201 transmits, via the CEC-based network, a CEC-protocol-based identifier report message to the second media control target device 202 connected thereto through the HDMI (operation S4103). Here, the identifier report message may include the identifier of the first media control target device 201.

The second media control target device 202 transmits, to the media control device 205, a home-network-protocol-based connection information message including the identifier of the first media control target device 201 via the IP-based home network (operation S4111).

The media control device 205 validates an HDMI connection on the basis of the received connection information message (operation S4113). Since the connection information message transmitted by the second media control target device 202 includes the identifier of the first media control target device 201, the media control device 205 may ascertain that the first media control target device 201 is connected to the second media control target device 202 through the HDMI.

As described above, the media control device 205 may collect information of media control target devices within the home network. The collected information may include an IP address of each media control target device, a CEC address of each media control target device, a CEC address of a device connected to each media control target device through the HDMI, and an identifier of a device connected to each media control target device through the HDMI.

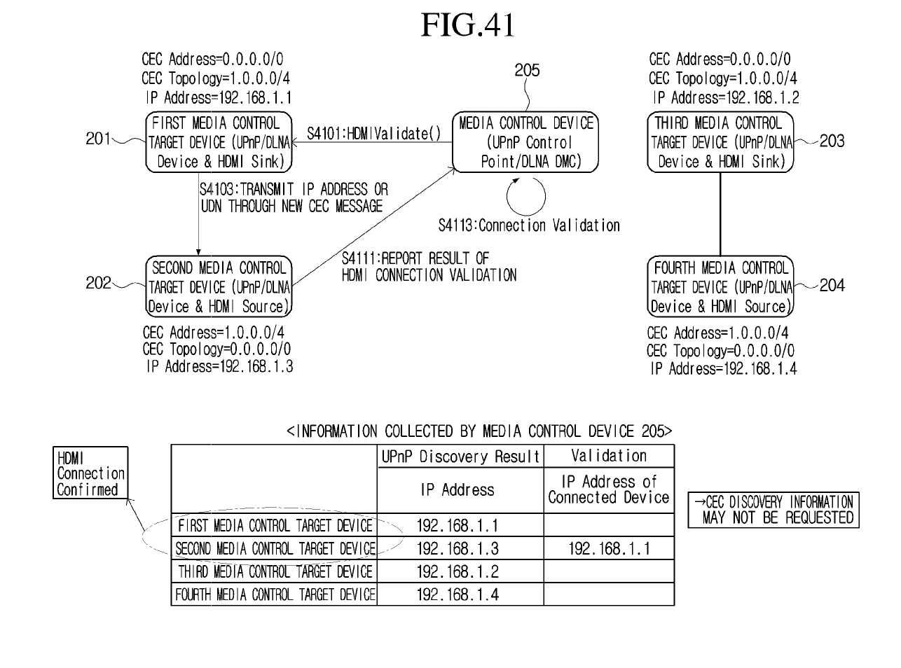

FIG. 41 is a diagram illustrating a network topology of an identifier-based HDMI connection validating method according to an embodiment.

It is assumed that the network topology of FIG. 41 is the same as the network topology of FIG. 31.

Since the procedure of FIG. 41 is the same as that of FIG. 40, a detailed description of the procedure of FIG. 41 is omitted.

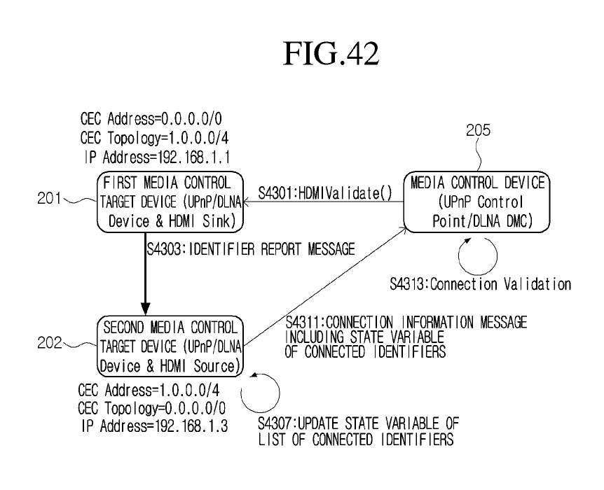

However, the media control device 205 may collect information different from that described above with reference to FIG. 40. That is, since the media control device 205 is able to validate an HDMI connection on the basis of an identifier without using the CEC address of each media control target device and the CEC topology information, the information collected by the media control device 205 may include the IP address of each media control target device and the identifier of a device connected to each media control target device through the HDMI. That is, in another embodiment, the media control device 205 may not perform operation S210 corresponding to the above-mentioned CEC discovery process. FIG. 42 is a diagram illustrating a network topology of an identifier-based HDMI connection validating method according to an embodiment.

It is assumed that the network topology of FIG. 42 is the same as the network topology of FIG. 31.

The media control device 205 transmits an HDMI connection validation message based on the home network protocol to the first media control target device 201 corresponding to an HDMI connection validation target device, via the IP-based home network (operation S4301). In the embodiment of FIG. 42, the HDMI connection validation message is a message of a request for sending, to a device connected through the HDMI, a CEC-protocol-based identifier report message via the CEC-based network.

When the first control target device 201 receives the home-network-protocol-based HDMI connection validation message, the first media control target device 201 transmits, via the CEC-based network, a CEC-protocol-based identifier report message to the second media control target device 202 connected thereto through the HDMI (operation S4303). Here, the identifier report message may include the identifier of the first media control target device 201.

The second media control target device 202 updates, on the basis of the identifier report message, a state variable for recording a list of identifiers of devices connected thereto through the HDMI (operation S4307). Referring to FIG. 42, since the second media control target device 202 is connected to the first media control target device 201 alone through the HDMI, and the second media control target device 202 receives the identifier report message from the first media control target device 201, the state variable for the identifier list only includes the identifier of the first media control target device 201. However, if the second media control target device 202 is connected to another media control target device through the HDMI in addition to the first media control target device 201, and has previously received the identifier report message from the other media control target device, the state variable for the identifier list includes the identifier of the first media control target device 201 and the identifier of the other media control target device.

When the state variable for recording the list of identifiers of devices connected to the second media control target device 202 through the HDMI is changed by update, the second media control target device 202 transmits a home-network-protocol-based connection information event message including the state variable for the list of identifiers to the media control device 205 via the IP-based home network, although the media control device 205 does not request the list of identifiers (operation S4311).

The media control device 205 validates an HDMI connection on the basis of the received connection information event message (operation S4313). Since the connection information message transmitted by the second media control target device 202 includes the identifier of the first media control target device 201, the media control device 205 may ascertain that the first media control target device 201 is connected to the second media control target device 202 through the HDMI.

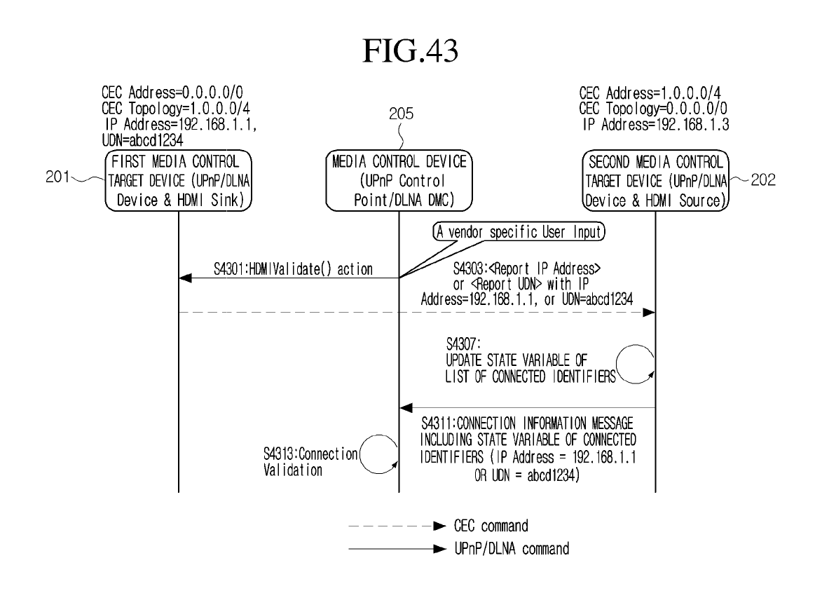

FIG. 43 is a diagram illustrating a network topology of an identifier-based HDMI connection validating method in a 3-box model according to an embodiment.

It is assumed that the network topology of FIG. 43 is the same as the network topology of FIG. 31.

Since the procedure of FIG. 43 is the same as that of FIG. 42, a detailed description of the procedure of FIG. 43 is omitted.

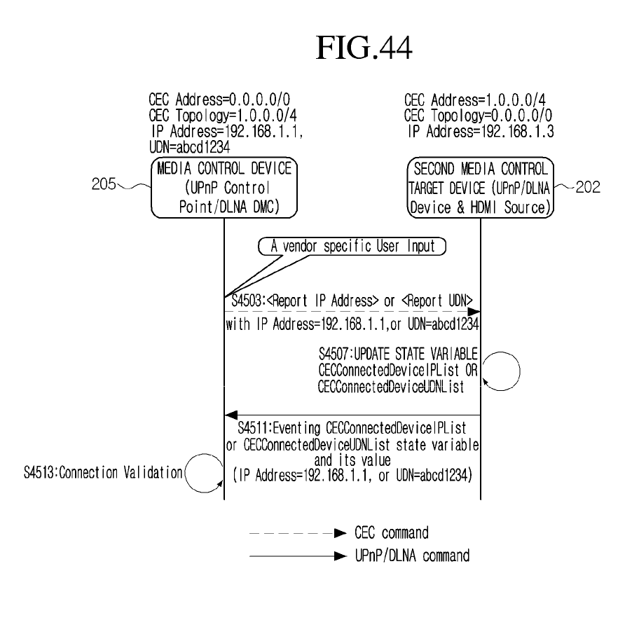

FIG. 44 is a diagram illustrating a network topology of an identifier-based HDMI connection validating method in a 2-box model according to an embodiment.

It is assumed that the network topology of FIG. 44 is the same as the network topology of FIG. 35.

The media control device 205 transmits, via the CEC-based network, a CEC-protocol-based identifier report message to the second media control target device 202 connected through the HDMI (operation S4503). Here, the identifier report message may include the identifier of the media control device 205.

The second media control target device 202 updates, on the basis of the identifier report message, a state variable for recording a list of identifiers of devices connected thereto through the HDMI (operation S4507).

When the state variable for recording the list of identifiers of devices connected to the second media control target device 202 through the HDMI is changed by update, the second media control target device 202 transmits a home-network-protocol-based connection information event message including the state variable for the list of identifiers to the media control device 205 via the IP-based home network, although the media control device 205 does not request the list of identifiers (operation S4511).

The media control device 205 validates an HDMI connection on the basis of the received connection information event message (operation S4513). Since the connection information message transmitted by the second media control target device 202 includes the identifier of the media control device 205, the media control device 205 may ascertain that the media control device 205 is connected to the second media control target device 202 through the HDMI.

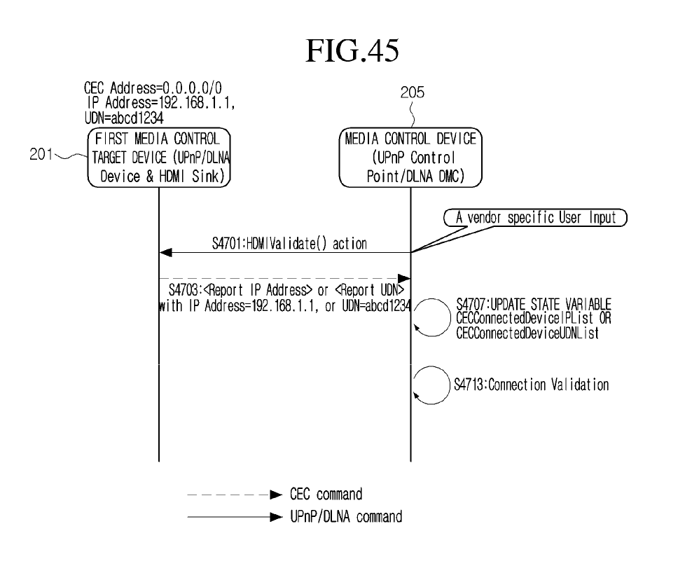

FIG. 45 is a diagram illustrating a network topology of an identifier-based HDMI connection validating method in a 2-box model according to an embodiment.

It is assumed that the network topology of FIG. 45 is the same as the network topology of FIG. 36.

The media control device 205 transmits an HDMI connection validation message based on the home network protocol to the first media control target device 201 corresponding to an HDMI connection validation target device, via the IP-based home network (operation S4701). In the embodiment of FIG. 45, the HDMI connection validation message is a message of a request for sending, to a device connected through the HDMI, a CEC-protocol-based identifier report message via the CEC-based network.

When the first control target device 201 receives the home-network-protocol-based HDMI connection validation message, the first media control target device 201 transmits, via the CEC-based network, the CEC-protocol-based identifier report message to the media control device 205 connected through the HDMI (operation S4703). Here, the identifier report message may include the identifier of the first media control target device 201.

The second media control target device 202 updates, on the basis of the identifier report message, a state variable for recording a list of identifiers of devices connected thereto through the HDMI (operation S4707).

The media control device 205 validates an HDMI connection on the basis of the state variable for recording the list of identifiers (operation S4713). Since the list of identifiers includes the identifier of the first media control target device 201, the media control device 205 may ascertain that the first media control target device 201 is connected to the media control device 205 through the HDMI.

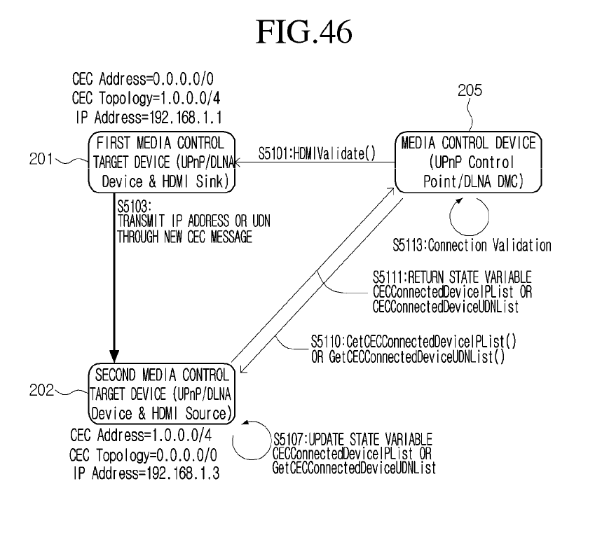

FIG. 46 is a diagram illustrating a network topology of an identifier-based HDMI connection validating method according to an embodiment.

It is assumed that the network topology of FIG. 46 is the same as the network topology of FIG. 31.

The media control device 205 transmits an HDMI connection validation message based on the home network protocol to the first media control target device 201 corresponding to an HDMI connection validation target device, via the IP-based home network (operation S5101). In the embodiment of FIG. 46, the HDMI connection validation message is a message of a request for sending, to a device connected through the HDMI, a CEC-protocol-based identifier report message via the CEC-based network.

When the first control target device 201 receives the home-network-protocol-based HDMI connection validation message, the first media control target device 201 transmits, via the CEC-based network, a CEC-protocol-based identifier report message to the second media control target device 202 connected thereto through the HDMI (operation S5103). Here, the identifier report message may include the identifier of the first media control target device 201.

The second media control target device 202 updates, on the basis of the identifier report message, a state variable for recording a list of identifiers of devices connected thereto through the HDMI (operation S5107).

The media control device 205 transmits a connection information request message based on the home network protocol to the second media control target device 202 via the IP-based home network (operation S5110).

The second media control target device 202 transmits, to the media control device 205, a home-network-protocol-based connection information response message including the state variable for the list of identifiers via the IP-based home network (operation S5111).

The media control device 205 validates an HDMI connection on the basis of the received connection information event message (operation S5113). Since the connection information message transmitted by the second media control target device 202 includes the identifier of the first media control target device 201, the media control device 205 may ascertain that the first media control target device 201 is connected to the second media control target device 202 through the HDMI.

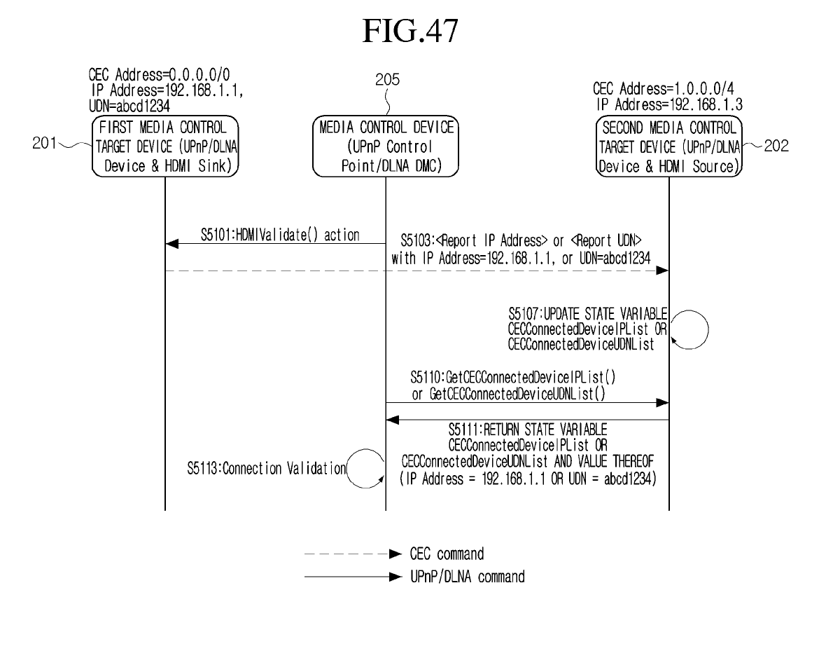

FIG. 47 is a diagram illustrating a network topology of an identifier-based HDMI connection validating method in a 3-box model according to an embodiment.

It is assumed that the network topology of FIG. 47 is the same as the network topology of FIG. 31.

Since the procedure of FIG. 47 is the same as that of FIG. 46, a detailed description of the procedure of FIG. 47 is omitted.

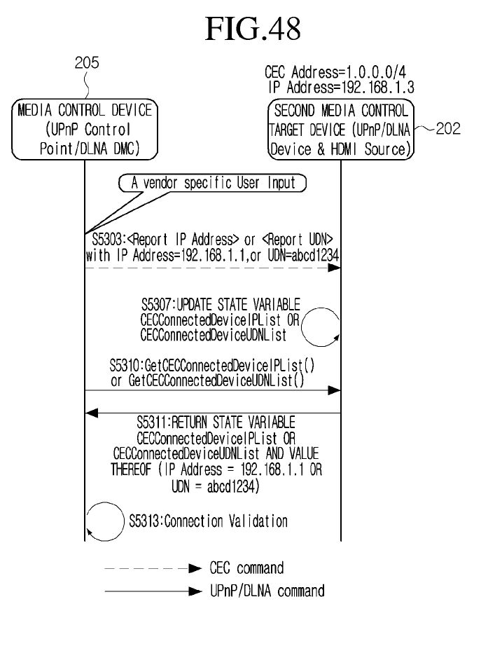

FIG. 48 is a diagram illustrating a network topology of an identifier-based HDMI connection validating method in a 2-box model according to an embodiment.

It is assumed that the network topology of FIG. 48 is the same as the network topology of FIG. 35.

The media control device 205 transmits, via the CEC-based network, a CEC-protocol-based identifier report message to the second media control target device 202 connected through the HDMI (operation S5503). Here, the identifier report message may include the identifier of the media control device 205.

The second media control target device 202 updates, on the basis of the identifier report message, a state variable for recording a list of identifiers of devices connected thereto through the HDMI (operation S5307).

The media control device 205 transmits a connection information request message based on the home network protocol to the second media control target device 202 via the IP-based home network (operation S5310).

The second media control target device 202 transmits, to the media control device 205, a home-network-protocol-based connection information response message including the state variable for the list of identifiers via the IP-based home network (operation S5311).

The media control device 205 validates an HDMI connection on the basis of the received connection information event message (operation S5313). Since the connection information message transmitted by the second media control target device 202 includes the identifier of the media control device 205, the media control device 205 may ascertain that the media control device 205 is connected to the second media control target device 202 through the HDMI.

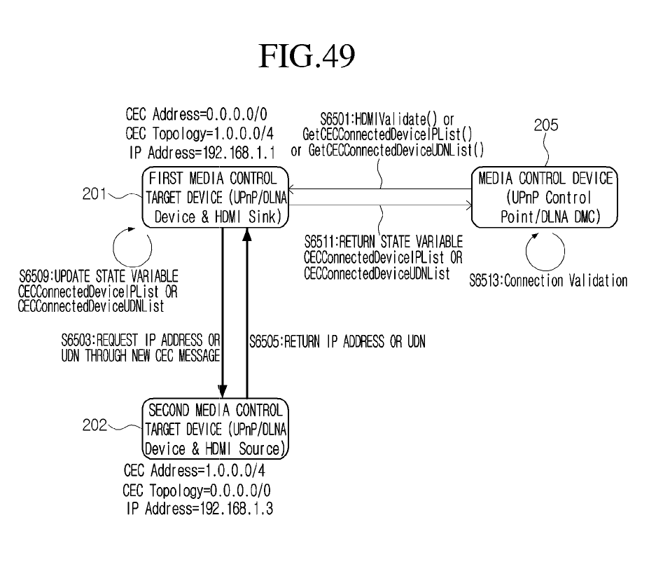

FIG. 49 is a diagram illustrating a network topology of an identifier-based HDMI connection validating method according to an embodiment.

It is assumed that the network topology of FIG. 49 is the same as the network topology of FIG. 31.

The media control device 205 transmits an HDMI connection validation message based on the home network protocol to the first media control target device 201 corresponding to an HDMI connection validation target device, via the IP-based home network (operation S6101). In the embodiment of FIG. 49, the HDMI connection validation message is a message of a request for sending, to a device connected through the HDMI, a CEC-protocol-based identifier request message via the CEC-based network.

When the first control target device 201 receives the home-network-protocol-based HDMI connection validation message, the first media control target device 201 transmits, via the CEC-based network, a CEC-protocol-based identifier request message to the second media control target device 202 connected thereto through the HDMI (operation S6103).

When the first media control target device 201 transmits, to the second media control target device 202 connected thereto through the HDMI, the CEC-protocol-based identifier request message via the CEC-based network, the second media control target device 202 transmits an identifier report message that is a message of response to the received identifier request message to the first media control target device 201 via the CEC-based network (operation S6105). Here, the response message is based on the CEC protocol.

The first media control target device 201 updates, on the basis of the identifier report message, a state variable for recording a list of identifiers of devices connected thereto through the HDMI (operation S6109).

When the state variable for recording the list of identifiers of devices connected to the first media control target device 201 through the HDMI is changed by update, the first media control target device 201 may transmit, as a response to the home-network-protocol-based HDMI connection validation message, a connection information message including information on the list of identifiers to the media control device 205 (operation S6111).

The media control device 205 validates an HDMI connection on the basis of the received connection information message (operation S6113). Since the connection information message transmitted by the first media control target device 201 includes the identifier of the second media control target device 201, the media control device 205 may ascertain that the first media control target device 201 is connected to the second media control target device 202 through the HDMI.

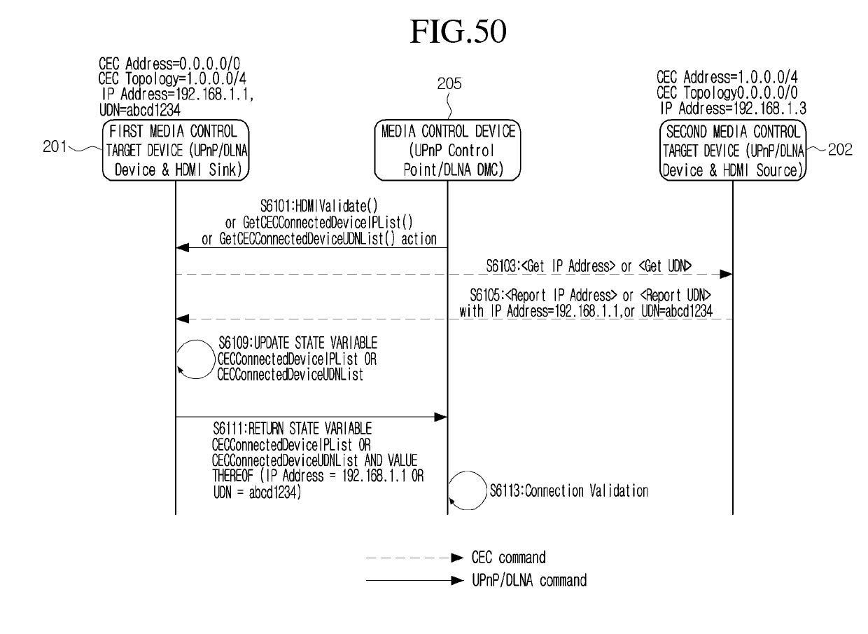

FIG. 50 is a diagram illustrating a network topology of an identifier-based HDMI connection validating method in a 3-box model according to an embodiment.

It is assumed that the network topology of FIG. 50 is the same as the network topology of FIG. 31.

Since the procedure of FIG. 50 is the same as that of FIG. 49, a detailed description of the procedure of FIG. 50 is omitted.

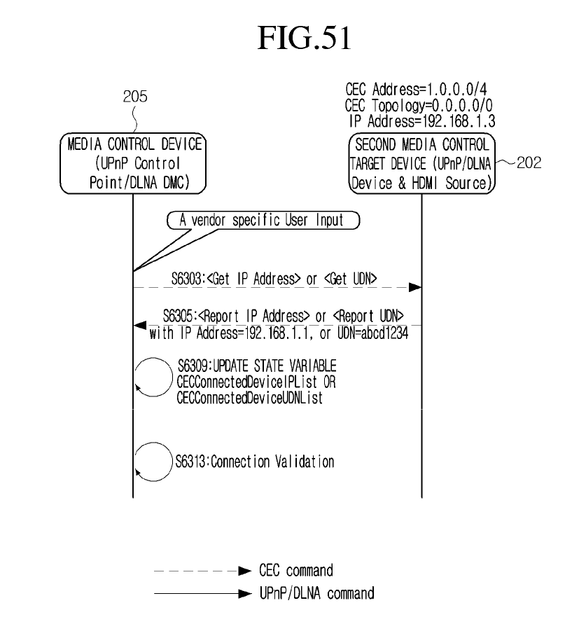

FIG. 51 is a diagram illustrating a network topology of an identifier-based HDMI connection validating method in a 2-box model according to an embodiment.

It is assumed that the network topology of FIG. 51 is the same as the network topology of FIG. 35.

The media control device 205 transmits, via the CEC-based network, a CEC-protocol-based identifier request message to the second media control target device 202 connected through the HDMI (operation S6303).

When the media control device 205 transmits, to the second media control target device 202 connected thereto through the HDMI, the CEC-protocol-based identifier request message via the CEC-based network, the second media control target device 202 transmits an identifier report message that is a message of response to the received identifier request message to the media control device 205 via the CEC-based network (operation S6305). Here, the response message is based on the CEC protocol.

The media control device 205 updates, on the basis of the identifier report message, a state variable for recording a list of identifiers of devices connected thereto through the HDMI (operation S6309).

The media control device 205 validates an HDMI connection on the basis of the received identifier report message (operation S6313). Since the CEC-protocol-based identifier report message includes the identifier of the second media control target device 202, the media control device 205 may ascertain that the media control device 205 is connected to the second media control target device 202 through the HDMI.

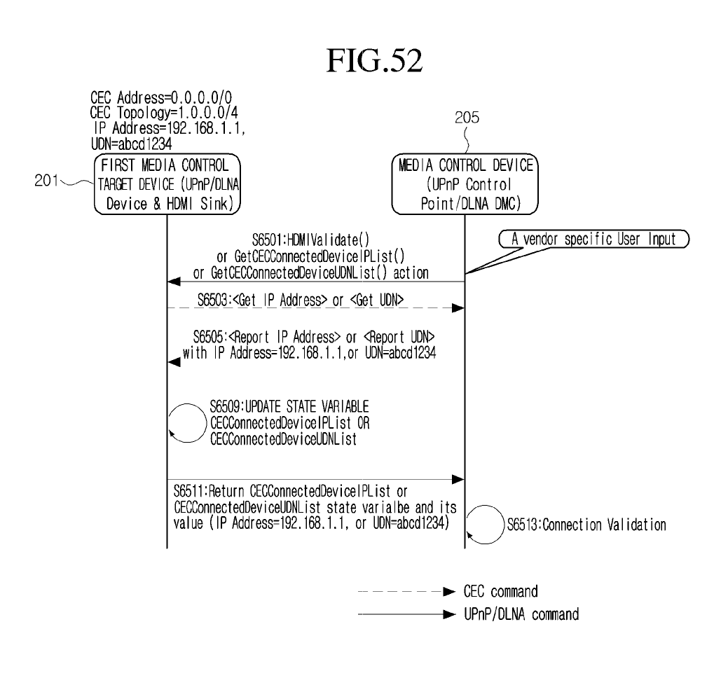

FIG. 52 is a diagram illustrating a network topology of an identifier-based HDMI connection validating method in a 2-box model according to an embodiment.

It is assumed that the network topology of FIG. 52 is the same as the network topology of FIG. 36.

The media control device 205 transmits an HDMI connection validation message based on the home network protocol to the first media control target device 201 corresponding to an HDMI connection validation target device, via the IP-based home network (operation S6501). In the embodiment of FIG. 52, the HDMI connection validation message is a message of a request for sending, to a device connected through the HDMI, a CEC-protocol-based identifier request message via the CEC-based network.

When the first control target device 201 receives the home-network-protocol-based HDMI connection validation message, the first media control target device 201 transmits, via the CEC-based network, the CEC-protocol-based identifier request message to the media control device 205 connected through the HDMI (operation S6503).

When the first media control target device 201 transmits, to the media control device 205 connected thereto through the HDMI, the CEC-protocol-based identifier request message via the CEC-based network, the media control device 205 transmits an identifier report message that is a message of response to the received identifier request message to the first media control target device 201 via the CEC-based network (operation S6505).

The first media control target device 201 updates, on the basis of the identifier report message, a state variable for recording a list of identifiers of devices connected thereto through the HDMI (operation S6509).

When the state variable for recording the list of identifiers of devices connected to the first media control target device 201 through the HDMI is changed by update, the first media control target device 201 may transmit, as a response to the home-network-protocol-based HDMI connection validation message, a home-network-protocol-based connection information message including information on the list of identifiers to the media control device 205 (operation S6511).

The media control device 205 validates an HDMI connection on the basis of the received connection information message (operation S6513). Since the connection information message transmitted by first media control target device 201 includes the identifier of the media control device 205, the media control device 205 may ascertain that the first media control target device 201 is connected to the media control device 205 through the HDMI.

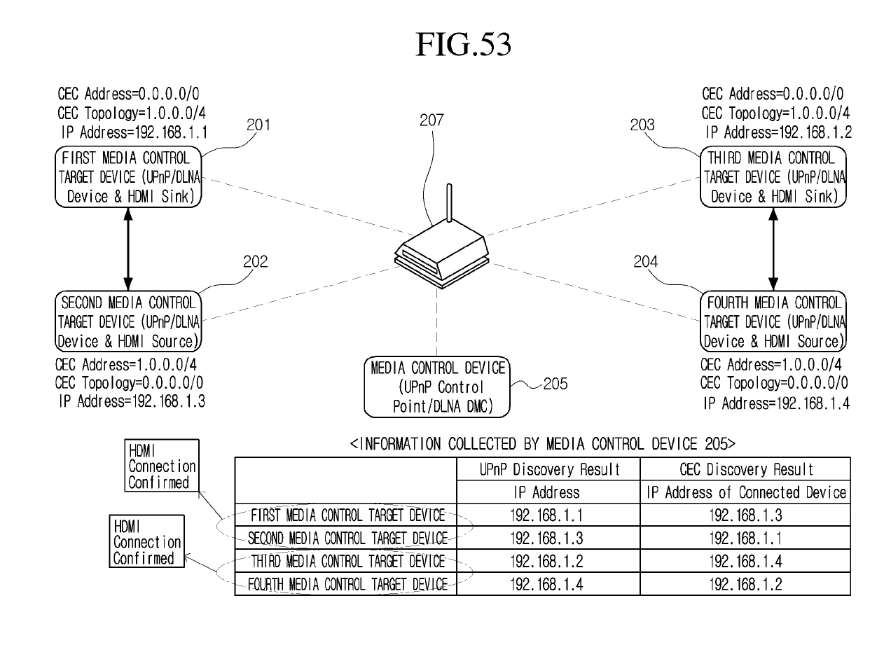

FIG. 53 is a diagram illustrating a network topology of an identifier-based HDMI connection validating method according to an embodiment.

It is assumed that the network topology of FIG. 53 is the same as the network topology of FIG. 31.

Using the above-mentioned identifier-based HDMI connection validating method, for example, the media control device 205 may collect the information illustrated in FIG. 53. The information collected by the media control device 205 may include an IP address of each media control target device and an identifier of a device connected to each media control target device through the HDMI.

As described above, even though devices having identical CEC address information exist within the same network, the media control device 205 may detect an HDMI connection relation correctly.

The various embodiments described herein may be implemented, for example, in a recording medium readable by a computer or a similar device using software, hardware, or a combination thereof.

For implementation with hardware, the embodiments described herein may be implemented using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and other electric units. In some cases, the embodiments may be implemented with the control unit 780.

The above-mentioned control methods according to the embodiments may be implemented as a program to be executed in a computer and may be stored in a computer-readable recording medium. The computer-readable recording medium includes a ROM, a RAM, a CD-ROM, a magnetic tape, a floppy disk, and an optical data storage device. Furthermore, the methods may also be implemented as a form of a carrier wave (for example, transmission via the Internet).

The computer-readable recording medium may be distributed to computer systems connected to a network so that computer-readable codes may be stored and executed in a distribution manner. Further, a function program, a code, and code segments for implementing the methods may be easily derived by programmers skilled in the art.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method for operating a media control device for controlling a first media control target device and a second media control target device, the method comprising:
transmitting an HDMI connection validation message based on a home network protocol to the first media control target device via an IP-based home network so that the first media control target device transmits a first message based on a CEC protocol to the second media control target device via a CEC-based network;
receiving an HDMI connection information message based on the home network protocol via the IP-based home network; and
validating an HDMI connection between the first media control target device and the second media control target device on the basis of the HDMI connection information message.

2. The method according to claim 1, wherein
the HDMI connection validation message is a message of a request for transmitting a CEC-protocol-based HDMI connection validation test message via the CEC-based network, wherein
the first message is the CEC-protocol-based HDMI connection validation test message.

3. The method according to claim 2, wherein the receiving the HDMI connection information message comprises:
receiving the HDMI connection information message based on the home network protocol from the second media control target device via the IP-based home network.

4. The method according to claim 3, wherein the HDMI connection information message is a home-network-protocol-based message comprising information on a last HDMI connection validation time.

5. The method according to claim 4, wherein the validating the HDMI connection between the first media control target device and the second media control target device on the basis of the HDMI connection information message comprises:
recognizing that the first media control target device is connected to the second media control target device through an HDMI when a difference between a time at which the HDMI connection validation message is transmitted and the last HDMI connection validation time is within a reference value.

6. The method according to claim 5, wherein the receiving the HDMI connection information message comprises:
receiving the HDMI connection information message as an event without a request for the HDMI connection information message.

7. The method according to claim 5, wherein the receiving the HDMI connection information message comprises:
requesting the HDMI connection information message and receiving the HDMI connection information message.

8. The method according to claim 3, wherein the HDMI connection information message is a home-network-protocol-based ACK message.

9. The method according to claim 1, wherein
the HDMI connection validation message is a message of a request for transmitting an identifier report message based on the CEC protocol via the CEC-based network, wherein
the first message is the identifier report message, wherein
the identifier report message comprises an identifier of the first media control target device.

10. The method according to claim 9, wherein the HDMI connection information message comprises a list of identifiers of connected devices.

11. The method according to claim 10, wherein the identifier of the first media control target device is an IP address of the first media control target device.

12. The method according to claim 10, wherein the identifier of the first media control target device is a home-network-protocol-based unique device name of the first media control target device.

13. The method according to claim 1, wherein
the HDMI connection validation message is a message of a request for transmitting an identifier request message based on the CEC protocol via the CEC-based network, wherein
the first message is the identifier request message.

14. The method according to claim 13, wherein the receiving the HDMI connection information message comprises:
receiving the HDMI connection information message based on the home network protocol from the first media control target device via the IP-based home network.

15. The method according to claim 14, wherein the HDMI connection information message comprises a list of identifiers of connected devices.

16. A method for operating a first media control target device controlled by a media control device, the method comprising:
receiving an HDMI connection validation message based on a home network protocol from the media control device via an IP-based home network; and
transmitting a first message based on a CEC protocol to a second media control target device via a CEC-based network upon receiving the HDMI connection validation message, so that the first media control target device or the second media control target device transmits an HDMI connection information message based on the home network protocol to the media control device via the IP-based home network, and the media control device validates an HDMI connection between the first media control target device and the second media control target device on the basis of the HDMI connection information message.

17. The method according to claim 16, wherein
the HDMI connection validation message is a message of a request for transmitting a CEC-protocol-based HDMI connection validation test message via the CEC-based network, wherein
the first message is the CEC-protocol-based HDMI connection validation test message.

18. The method according to claim 16, wherein
the HDMI connection validation message is a message of a request for transmitting an identifier report message based on the CEC protocol via the CEC-based network, wherein
the first message is the identifier report message, wherein
the identifier report message comprises an identifier of the first media control target device.

19. The method according to claim 16, wherein
the HDMI connection validation message is a message of a request for transmitting an identifier request message based on the CEC protocol via the CEC-based network, wherein
the first message is the identifier request message.

20. A method for operating a second media control target connected by an HDMI connection to a first media control target device controlled by a media control device, the method comprising:
receiving, via a CEC-based network, a first message based on a CEC protocol from the media control device receiving an HDMI connection validation message based on a home network protocol via an IP-based home network; and
transmitting an HDMI connection information message based on the home network protocol to the media control device via the IP-based home network, so that the media control device validates the HDMI connection between the first control target device and the second media control target device on the basis of the HDMI connection information message.
